(19) United States
(12) Patent Application Publication
(10) Pub. No.: US 2002/0083658 A1
(43) Pub. Date: Jul. 4, 2002

(54) Block system

(76) Inventor: Ted C. Dial, JR., Mobile, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/752,216

(22) Filed: Dec. 29, 2000

Related U.S. Application Data
(63) Continuation-in-part of application No. 09/270,888, filed on Mar. 17, 1999, now Pat. No. 6,032,424.
(63) Continuation-in-part of application No. 09/468,531, filed on Dec. 21, 1999, now Pat. No. 6,223,491.
(60) Provisional application No. 60/078,992, filed on Mar. 23, 1998.

(51) Int. Cl. G06F 17/50; E04H 12/34; E04G 21/14; E02D 35/00

(52) U.S. Cl. 52/125.4; 52/596; 52/742.1; 703/1

(57) ABSTRACT

A construction block is disclosed along with a method of producing and assembling a plurality of the construction blocks where the blocks have internal cages around a central passage, said central passage opening to top, bottom or side openings in the blocks, and from which cage support rods extend to hook chain lifts to the blocks and to guide bottom openings of top blocks into predetermined alignment with the top opening of the bottom blocks. The casting technique allows not only for the novel lifting and alignment construction of the blocks, but also allows for novel external and internal features to be incorporated into the blocks, such as studs, mounting bolts for interior walls and bricks or brick facades for the exterior walls of the blocks.

### PRIORITY

Priority is claimed on PROVISIONAL PATENT no: 60/078,992 filed Mar. 23, 1998 by Ted Dial and is a continuation in part of U.S. patent application Ser. No: 09/270,888 filed Mar. 17, 1999 and U.S. patent application Ser. No.:09/468,531 filed Dec. 21, 1999.

### KNOWN PRIOR ART

The prior art shows embedded lifting mechanisms. The prior art also shows building members and concrete building members having hollow interiors. The prior art also shows building members assembled to receive a concrete matrix.

### GENERAL DISCUSSION OF THE INVENTION

The invention is a plurality of building block and a building process using the specialized blocks for constructing walls, building exteriors, decorative architectural detail, cornices, eaves, window casings, door casings and lintels built independently and in conjunction with walls. Several processes for constructing the blocks are also taught. The invention uses blocks which, when assembled, have a series of intersecting chambers which allow for a continuous concrete pour throughout the structure in order to secure the blocks together. The blocks are defined by specialized exterior features, by the channel system, by the cage and by the opening layout and method for lifting and centering one block on top of another.

The invention allows for a strong structure where certain architectural details become part of the structure as opposed to being mounted onto the structure or attached to the structure. No attachment devices or fasteners are needed as are found in other known practices of constructing architectural details such as eaves, cornices and the like. Incorporation of these features into poured block structures which are integral parts of the exterior walls saves time and labor costs.

In the preferred embodiment, the products are pre-fabricated for shipping and construction. No exterior finishes are required to be added during construction because all desired finishes and desired shapes, both decorative and functional, are already part of this structural product. The structural integrity of the building (framing, etc), the interior finish surfaces, the weather control, and the decoration are all one and the same.

It is therefore an object of the invention to provide an easily constructed and moved building member.

Another object of the invention is to provide a block which can easily be lifted in place by at least one lifting rod and thereafter stacked and filled with concrete or other matrix without the rod interfering with the concrete pour.

It is a further object of the invention to provide for a process for making and using the modified blocks in order to construct structures with desired architectural detail with minimal labor.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF THE DRAWINGS

For a further understanding of the nature and objects of the present invention, reference should be made to the following detailed description taken in conjunction with the accompanying drawings in which like parts are given like reference numerals and wherein:

FIG. 1 is a plan view of one of the blocks described by the invention.

FIG. 2(a) is a plan view of a plug having a notched centering means and a cage mounted on the centering means with lifting rods.

FIG. 2(b) is a plan view of a jig having a notched centering means and raised guides for building properly centered cages.

FIG. 3 is a plan view of a cage having lifting rods.

FIG. 4 is a cut away view of a structural wall detail, here a window frame, of the type shown in FIG. 5 through the 4-4 axis of FIG. 5.

FIG. 4a is a cross section of the detail shown in FIG. 4 through the 4a-4a axis.

FIG. 4b is a cross section of FIG. 4a through the 4b-4b axis.

FIG. 5 is a window frame incorporating the structure described herein.

FIG. 6 is an exploded view of a mold used for making blocks.

FIG. 7 is a cross sectional view of a wall in a two story structure using the technology described herein.

FIG. 8 shows an assembled mold of the type shown in FIG. 6 with a modified cage.

FIG. 9 shows a press and pull mechanism for removing plugs from blocks poured in the mold.

FIG. 10 shows a plan view of the structure described in FIG. 7.

FIG. 11 shows an architectural detail of a window frame, such as is shown in FIG. 5, during the assembly process.

FIG. 12 shows a lintel block used in the construction of the window shown in FIG. 11.

FIG. 13 shows a wall being assembled using the blocks described herein.

FIG. 14 shows the wall of FIG. 13 with a cornice and top plate.

FIG. 15 shows an interior view of an alternate mold wall detail.

FIG. 16 shows a cross section of the mold using a wall from FIG. 15 through the 16-16 axis of the wall with one mold wall off.

FIG. 17 shows an interior view of an alternative mold wall detail.

FIG. 18a shows a cross section of the mold wall detail of FIG. 17 through the 18a- 18a axis using short studs as an attachment means.

FIG. 18b shows a cross section of the mold wall detail of FIG. 17 through the 18b-18b axis using a long stud as an attachment means

FIG. 19 shows a block wall produced using a mold detail such as that shown in FIG. 15.

FIG. 20 shows a rack plug front or end view.

FIG. 21 shows a rack plug side view.

FIG. 22 shows a rack buggy plan view.

FIG. 23 shows a rack buggy front view.

FIG. 24 shows a rack buggy side view.

FIG. 25 shows a rack buggy side view.

FIG. 26 shows a diagram view of a plant for processing concrete blocks.

FIG. 27 shows a unfolded rack as shown in FIG. 22 from a top view.

FIG. 28 shows a closed rack, as shown in FIG. 22, from a top view.

FIG. 29 shows a foam insert or core for covering a plug.

FIG. 30 shows a block incorporating a core.

FIG. 31 shows a block diagram of a de-plugging machine.

FIG. 32 shows a front cross section of an alternative mold design.

FIG. 33 shows a top view of the mold of FIG. 32.

FIG. 34 shows a side view of the mold of FIG. 32.

FIG. 35 shows the floor plate of the mold shown in FIG. 32.

FIG. 36 shows the mold section of FIG. 32 from a position from the center where the floor 227 can be seen.

FIG. 37 shows the movement of a mold wall when being connected to the mold in three steps (a) the wall separated, (b) the wall attached but open (here with the rod removed so the floor is not affected) and (c) with the mold assembled without the lifting rod.

FIG. 38 shows a modified core with an attached side core with foam punch outs.

FIG. 39 shows the side plug from FIG. 38.

FIG. 40 shows a top view of the plug from FIG. 38.

FIG. 41 shows a cross sectional side view of the plug from FIG. 38 with the side punch outs removed and a side plug on the right side.

FIG. 41 a shows a detailed cross section of the meeting of a plug and side plug.

FIG. 42 shows a side view of the plug of FIG. 40.

FIG. 43a shows a side view of the plug of FIG. 42.

FIG. 43b shows a side view of the plug of FIG. 42.

FIG. 44a shows the front view from FIG. 43.

FIG. 44b show the back view from FIG. 43.

FIG. 45a shows a cross sectional view from FIG. 39 from the left side.

FIG. 45b shows a cross sectional view from FIG. 39 from the right side.

FIG. 46a shows a side view of the side plug of FIG. 45 from the right side.

FIG. 46b shows a side view of the side plug of FIG. 45 from the right side.

FIG. 47 shows an alternate mold design allowing for 2 part blocks with side rods.

FIG. 48a shows a front view of the mold of FIG. 47.

FIG. 48b side a front view of the mold of FIG. 47.

FIG. 49 shows a plurality of molds on a platform prior to being joined by horizontal and vertical pipes.

FIG. 50 shows the placement of the block in a mold from FIG. 47.

FIG. 51 shows a perspective view of the block of FIG. 50.

FIG. 52a-52e show alternative molds having different plug layouts to make different flow paths.

FIG. 53a shows a long platform layout for molds.

FIG. 53b shows a short platform layout for molds.

FIG. 54 shows a side view of a loaded platform.

FIG. 55 shows a top view of the platform from FIG. 54.

FIG. 56a shows a cross section of a log block.

FIG. 56b shows a section of a log block.

FIG. 56c shows a side view of a log block.

### DETAILED DESCRIPTION OF THE PREFERRED EMBODIMENT

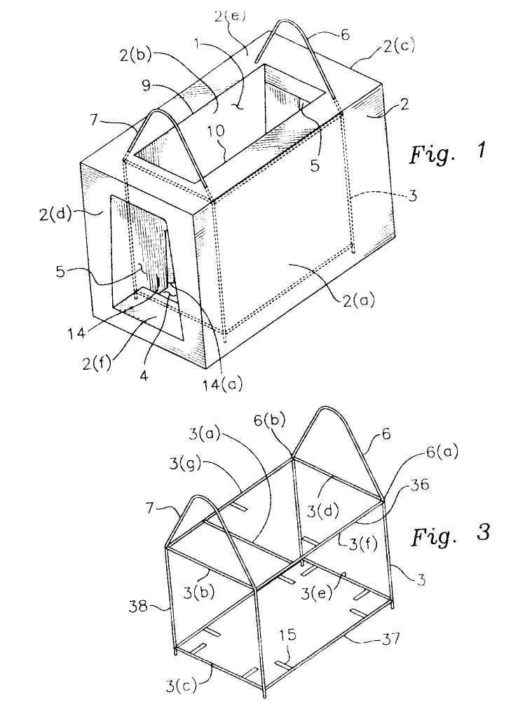

As can best be seen by FIG. 1, one invention comprises a specialized block 2 having a special purpose for construction of a building. The block, can be understood by reference to FIG. 1 which shows a perspective view of a block 2 utilizing the construction techniques set out herein. This block 2 comprises a block top opening 1 and at least one block additional opening, here a bottom opening 4 and a side opening 5. At least a portion of the internal area of the block is hollow in order to provide a passage which allows the block top open 1 to communicate with the block bottom opening 4 or side opening 5 or both.

The architectural block, as shown in FIGS. 1 and 3 comprises at least one cage (3) having a first side frame member (3f) within the first side (2a) of the block and a second side frame member (3g) within the second side (2b) of the block and wherein the cage (3) further comprises an attachment rod (3e) connecting the first side frame member (3f) to the second side frame member (3g) and wherein the at least one first guide rod (6) has a left side (6a) and a right side (6b) and wherein the left side (6a) of the first guide rod (6) is attached to the first side frame member (3f) and the right side (6b) is attached to the second side frame member (3g).

The block has a top (2e) and a bottom (2f), and further comprises a first side (2a), a second side (2b), a third side (2c) and a fourth side (2d) and said sides, top and bottom defining an enclosure which enclosure defines at least one first block opening (1) which is continuous with a passage through the block which passage may be continuous with at least one second block opening here bottom opening (4) in a second block if the second block is placed against the architectural block as shown in FIG. 13;

In the preferred embodiment the bottom opening 4 is larger than the top opening 1. The bottom opening 4 is large enough to receive first and second guiding rods 6 and 7 respectively. The guide rods 6 and 7 may come up from the center of the top opening or from the walls on either side of the top opening 1. The guide rods 6 are preferably curved at the top so that as a top block is lowered by its own guide rods 6 and 7 onto a lower block the bottom opening 4 of the top block accepts the guide rods 6 and 7 of the bottom block into the bottom opening 4 and the bottom edges 14 of the bottom opening 4 are guided by the guide rod 6 into the appropriate location. As a result, while only one guide rod is needed, at least a first guide 6 and a second guide 7 are present in the preferred embodiment for proper centering of a top block with a bottom block as shown in FIG. 13.

In the preferred embodiment, the bottom opening 4 is larger than the top opening 1 so that the guide rods will appropriately guide the bottom opening 4 in place over a lower block and also to make the concrete pours more even by preventing concrete build up within the pour. In addition, the edges 14 of the bottom opening 4 may be notched as shown in FIG. 1 so that these notches 14(a) could be guided over the rods 6 and 7.

The spacing and use of the guide rods 6 and 7 defines how many are needed and what shapes are possible. The size of the rods is governed by the strength requirements since the rods may serve a lifting purpose and a guiding purpose. In addition, the rods act as reinforcing rods when concrete is poured into the assembled blocks and may serve as attachment rods for additional reinforcing steel. The second guide rod 7 is shown here as being parallel to the first guide rod 6. However, it can easily be seen that it may be at an angle off parallel all the way to being perpendicular to form a dome for guiding a second block onto a first block.

In the preferred embodiment there are two rods 6 and 7 for easy lifting and the rods travel from the left side 9 of the top opening 1 to the right side 10 of the top opening 1. Once one block is on top in line with another lower block (as shown in FIG. 13) concrete may be poured through the top block top opening 1 and then it travels through to other blocks which have openings aligned with this top block. Side guide rods may extend from the side openings for a similar purpose although this is not necessary in the preferred embodiment given the function of the rods to allow for easy lifting and placement of the blocks.

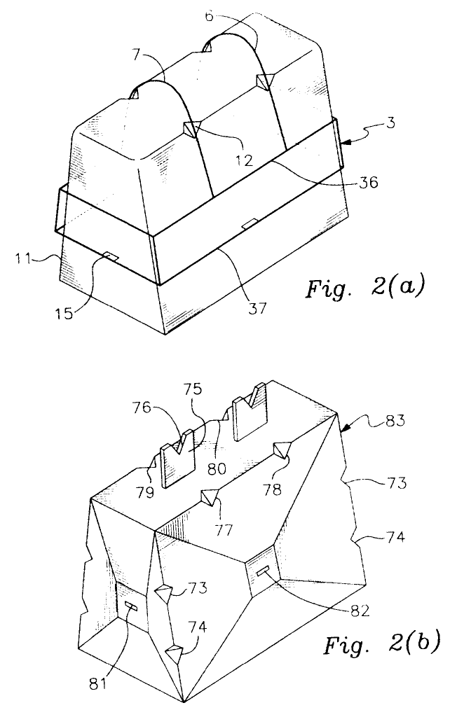

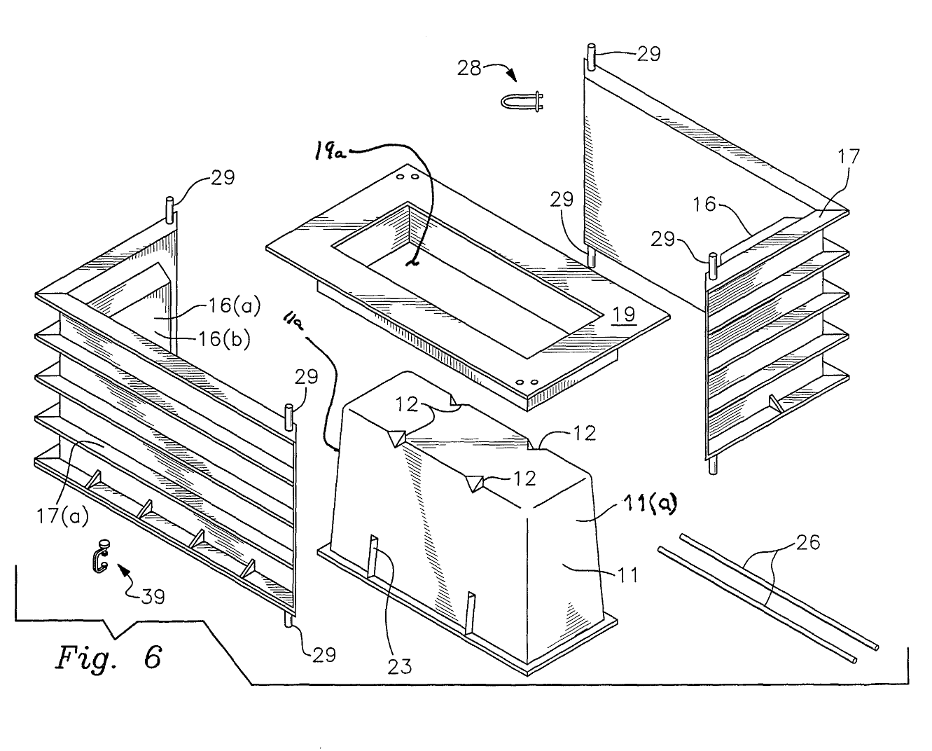

As shown in FIG. 1 and 2(A), when two guide rods are used, they can come off the cage 3 at different locations. One or more rods may be used. If one rod 6 were used, it would be preferably centered based on the weight of the block 2. Tabs or spacers 15 are attached to the cage, here at the bottom frame 37. The bottom legs of the cage may extend past the bottom frame 37 to support the cage off the base 19 of the plug 11 as shown in FIG. 6.

As can be seen by reference to FIG. 2(A) the edges of the plug 11 may be curved. In FIG. 2(A), when the cage is in place on the plug a portion of the guide rods lay on the notches 12 of the plug 11 so that the cage 3 is properly aligned. The cage side may have an upper part 36and lower part 37 running along the side of the plug 11.

As shown in FIG. 2(B), the internal cage 3 may be built on a jig which has top notches 73 and bottom notches 74 to receive the top frame 36 and bottom frame 37 respectively. Since the rods 6 and 7 must extend over the top, raised guides 75 may be used to assure the proper height of the guide rods 6 and 7. The raised guides 75 may define raised notches 76 which receive the guide rods 6 and 7 as they are run from one side of the cage over the raised guides 75 to the other side of the cage 3. To further guide the placement of the rods 6 and 7, right side notches 77 and 78 and left side notches 79 and 80 are provided. Rod 6 is to from the top frame 36, fit through right notch 78, into the nearer guide 75 within the notch 76, through the left notch 80 and back onto the far side of the top frame 36. This same design arrangement is provided for the other rod 7.

To provide proper placement of the tabs or spacers 15, short side spacer alignment 81 and long side spacer alignment 82 may be used to show where the spacer is to be inserted and to set the distance if the spacer 15 extends inward from the cage.

FIG. 3 shows the use of two rods 6 and 7. In order to allow the blocks to be lifted by the guide rods 6 and 7 an internal cage 3 is built within the block itself. One or more cross rods (3a) may extend through the center of the block between sides of the internal cage 4 in order to add additional re-enforcing strength to the concrete poured within the blocks.

The use of spacers 15 as shown in FIG. 3 throughout the cage 3 allows the cage to be centered on plug 11 even without notches 12.

As shown in FIG. 3 the cage 3 is preferably comprised of a bottom frame 37, a side frame 38 and a top frame 36 formed of interlocking metal bars of sufficient thickness to support the blocks when lifted by guide rods 6 and 7 when the block is lifted. While the guide rods 6 and 7 are shown at either side, of the cage, their number and location is discretionary as long as they serve their guiding function, their re-enforcing function, and their lifting function.

The internal cage not only allows for the lifting and strengthening the position of the guide rods but also adds structural strength to the concrete block 1. The cage may be partially or completely encased in concrete although at least a portion of it is preferably encased in concrete so that the block may be lifted by the rods 6 and 7 extending from the cage 4.

In the pouring process the cage may be suspended within the mold for the block. As shown in FIG. 2, the guide rod 6 may be centered on a notch 12 on a plug 11 to properly center the cage and this may also be done with spacers 15. Once in place and centered, concrete is poured into a mold as described in more detail below.

FIG. 6 shows a mold assembly. During assembly, a cage as shown in FIG. 2a or 3 is put in place before side plugs 16 and 16a are installed. FIG. 6 shows the assembly of a mold for manufacturing blocks with one bottom and two side openings. The mold consists of a bottom plug 11 which is fitted within an opening 19a in the base 19 of the mold. This bottom plug 11 will form the top opening 1 and bottom opening 4 if it fits all the way through the block. If only a top or bottom opening is desired, the plug will not pass all the way through. The cage 3, shown in FIG. 3, is then put on top of this plug 11 and the side walls 17 and 17a are attached so that either of the side plugs 16 or 16a would touch the bottom plug 11, if it is desired to have either of the side openings 5 in the block. As is obvious, if there is only one side plug 16 or 16a there will be only one side opening. If there are no side plugs, there will be no side openings. If a side plug does not reach the bottom plug 11, there would be an indented side, but no passage through the block. The user may break through the top of the indented side into the passage where the bottom plug 11 was formed if this passage was desired.

If there is no bottom plug 11, but the left side plug 16a and right side plug 16 touch, there will be side openings, but no bottom opening. If a top plug is inserted into this arrangement, there would be a top opening and side opening, but no bottom opening. Likewise, if the bottom plug 11 does not reach the top of the mold, there will be a bottom opening, but no top opening. Specialized blocks for comers, bottoms and tops may thereby be formed.

In the preferred embodiment, both the bottom plug 11 and side plugs 16 are tapered from the base 19 or wall 17, respectively, to a more narrow end to make removal easier. Since the bottom plug 11 is tapered from a wide base to a narrow top, the top face 16b of the side plug 16a is tapered so as to fit against the side face 11a of the bottom plug 11. This fit leaves little or no concrete between the faces 16a and 11a or leaves a thin enough sheet of concrete so that it may be easily punched out. Assembly bars 26 are inserted through the base 19 below the bottom of the plug 11 to hold the plug 11 in place during the pour. These rods 26 will later be removed to allow the plug to be removed.

Ridges 23, shown in FIG. 6, along the side of the plug 11 result in notches 14a along the bottom edges 14 of the bottom opening 4 of the poured block 2 as shown in FIG. 1.

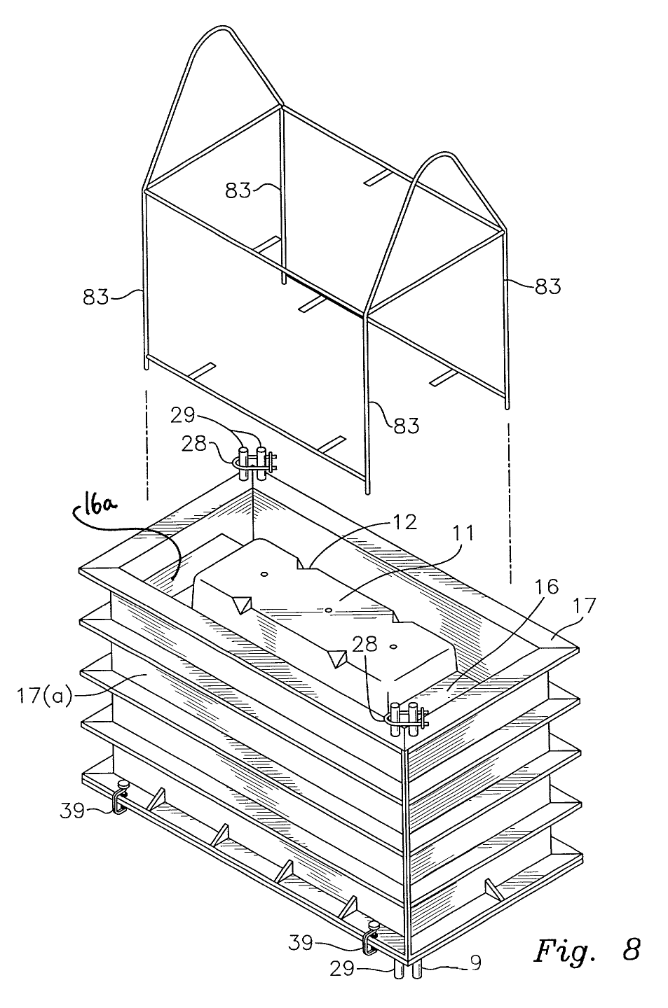

As can best be seen by reference to FIG. 8, c-clamps 28 attached to posts 29 on each of the two separate side walls 17 and 17a of the mold serve to hold the side walls together relative to one another as the mold is poured. The base 19 is also held to the side walls 17 and 17a by way of clamps 39.

When the mold is assembled, as shown in FIG. 8, the concrete may be poured into the mold. If desired, the top may be troweled smooth, exposing a portion of the plug top or having a thin enough layer over the plug top that it may be punched out. FIG. 8 shows the internal cage out of the assembled mold, but as discussed above, referring to FIG. 6, typically the cage would be put in before any side plugs 16. Here, in FIG. 8, the bottom of the cage 3 is open on the side. The side legs 83 can fit on either side of the side wall plugs 16 and 16(a) shown in FIG. 8.

It can be seen that if the side plugs 16 and 16a were to meet in the center without a bottom plug 11, the cage 3 could fit over the side plugs 16 and 16a. This would form a lifting rod over a block which had a passage which was below but not affected by the lifting rods. The lifting rods would still serve their lifting function. They would also serve their reinforcing function if a second block with a bottom opening were placed over the lifting rods.

After the plugs, walls and cage are assembled, concrete can be poured and the entire mold allowed to cure, fully or partially, at which point the plugs are pulled, pressed or knocked out and the block is ready to use.

Ridges 23 shown in FIG. 6 may rise from the bottom plug 11 to provide guides 14a (as shown in FIG. 1) in the finished block which receive the support bars 6 and 7 shown in FIG. 3 when one block is placed atop another. These ridges 23 may be of a variety of shapes without departing from the concept embodied herein.

After an appropriate amount of drying, the plugs 11 are then drawn out or pressed out or knocked out of the center of the block. The plugs 11 may have notches 12 which allow for them to assist in the alignment of the cage 9. The edges 13 are rounded and the size of the block is tapered in order to assist with the plug's removal. This tapering also leads to the larger size of the bottom block opening 4 versus the top block opening 1.

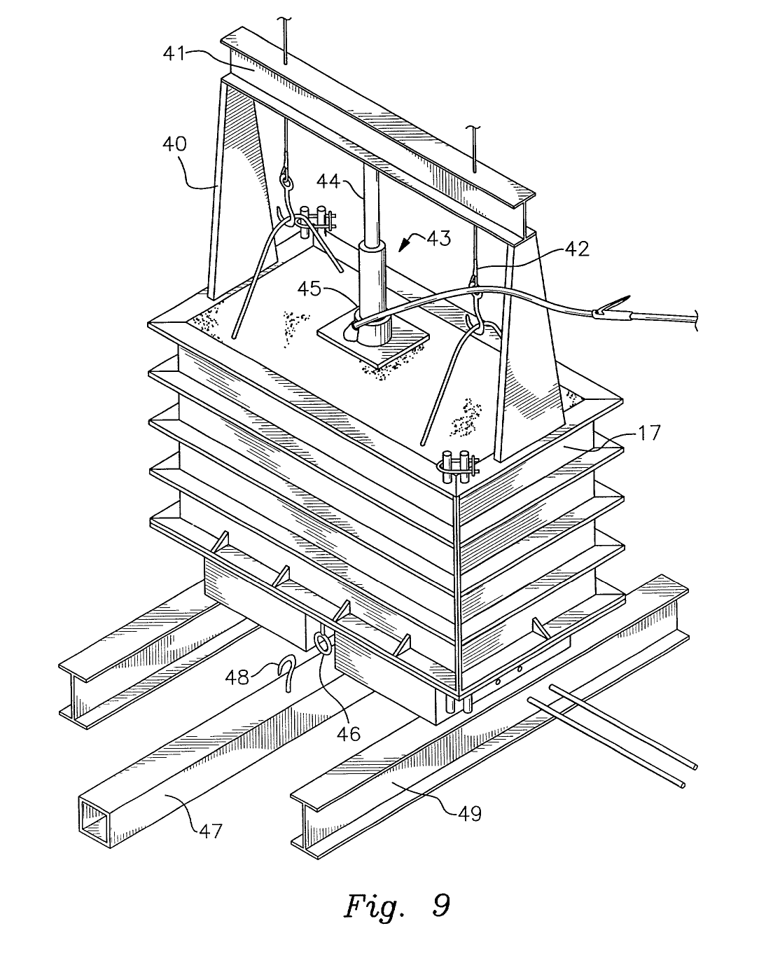

As can best be seen by reference to FIG. 9, after a block is produced within the mold, the plug 11 may be removed by jacking the plug 11 out or by pulling the plug out from the bottom or a combination of the two techniques. This may be done while the concrete is fully hardened or during the drying process when the mold is sufficiently set in order to allow the passages defined by the plugs to remain in place. There may be small holes in the plugs which receive pins to test the concrete for drying. In FIG. 9 it can be seen that brace supports 40 support a brace 41 against the sides of the mold. The brace 41 is also supported against the jack arm 44 by chains 42 hooked into the guiding rods 6 and 7 of the block. A jack 43 is inserted between the plug 11 and the brace 41 and as the jack arm 44 pushes against the brace 41, the jack base 45 pushes the plug 11 out.

FIG. 9 also shows the use of a eye-bolt 46 built into the bottom of the plug 11. This eye-bolt 46 may be attached to a hook 48 on a beam 47. This arrangement is held off the floor by placing the mold on I-beams 49 and the beam 47 is pressed to the floor, pulling the plug 11 from the mold. These same technologies may be used on the side plugs which are smaller and require less stress to remove.

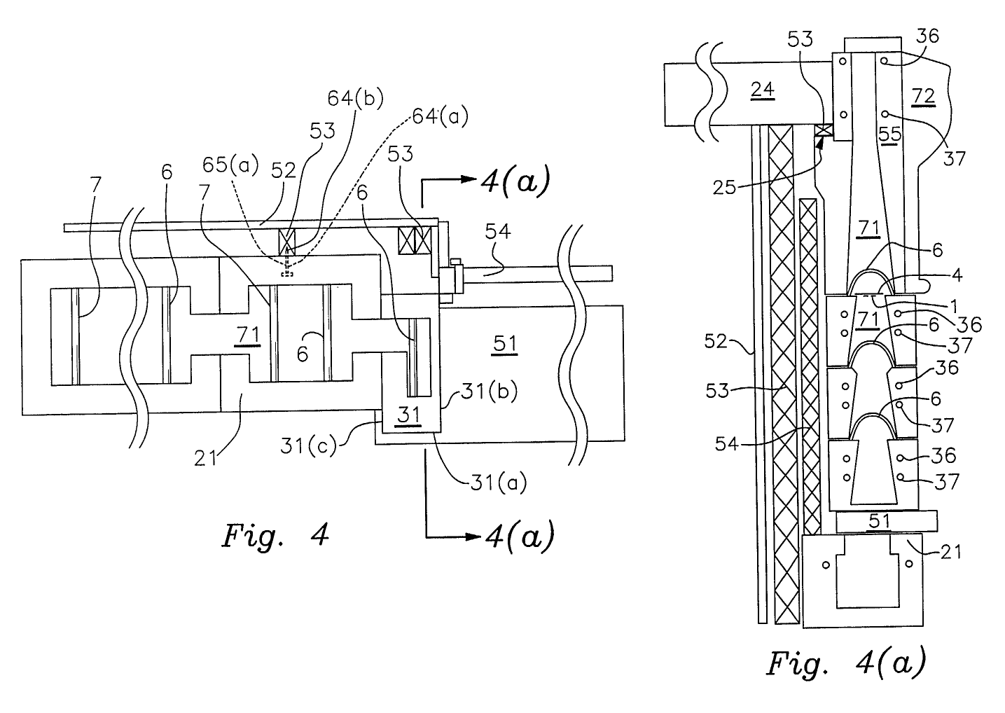

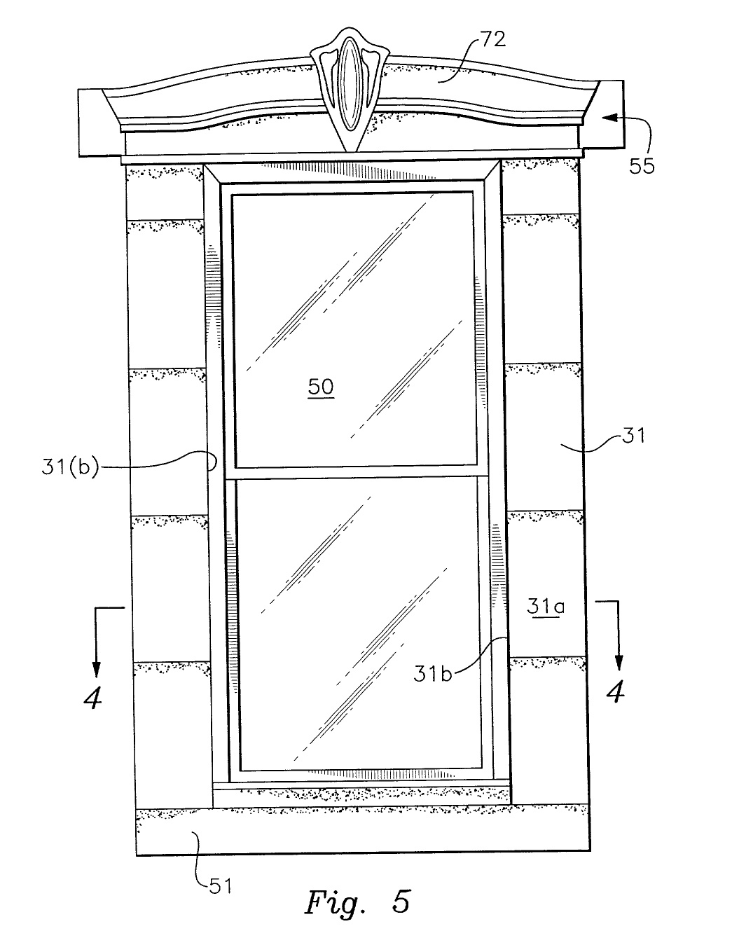

FIG. 5 shows the use of traditional framing on offsets created by the construction techniques utilized herein. Here, 8 inch wide [0.203 m] frame blocks 31 extend around the window 50. As seen looking down in cross section, 4-4, shown in FIG. 4, the 8 inch [0.203 m] frame blocks 31 are offset to stick out from the 16 inch [0.406 m] structural blocks 21 by a predetermined distance 31(c). The front face 31(a) of the blocks facing outward may be slightly less far out than the cast sill 51 on which the 8 inch [0.203 m] frame blocks 31 and window 50 rest. The actual window 50 is recessed from the front face 31(a) of the 8 inch [0.203 m] frame blocks 31. In this embodiment, the interior walls 52 are mounted on studs 53 embedded within the blocks although the mounting of walls to studs is known in the prior art. The window is recessed within the walls by a window casing 54 of the type also known in the art.

By way of example, the 8 inch [0.203 m] frame blocks 31 abut the 16 inch [0.406 m] structural blocks 21 which are here thirty inches [0.762 m] long and the frame blocks 31 may be indented within the 8 inch difference [0.203 m]. The side openings of the frame blocks 31 and structural blocks 21 would preferably be aligned as shown in FIG. 4 even though the blocks themselves are of different widths.

As shown in FIG. 5, a solid cast cornice or lintel 55 may be placed atop the window frame described by the 8 inch [0.203 m] frame blocks 31. This cornice 40 would be supported by and integral with the 8 inch [0.203 m] frame blocks.

FIG. 4(a) shows a side section of the cross section 4a-4a shown in FIG. 4. Several benefits of the blocks described above are apparent from this figure. Referring to the top block, lintel 55 of the window treatment is shown in FIG. 4(a). It can be seen that structural and design details may be incorporated into a poured block. The structural detail here is a plate 25 which receives a wooden wall stud 53 which, in turn, supports a beam 24. The plate 25 is a part of the poured block. In addition, this lintel block 55 incorporates a design exterior treatment 72. While both the plate 25 and exterior treatment 72 are shown here in a single block, it is obvious that either detail may be incorporated into such a block without the other.

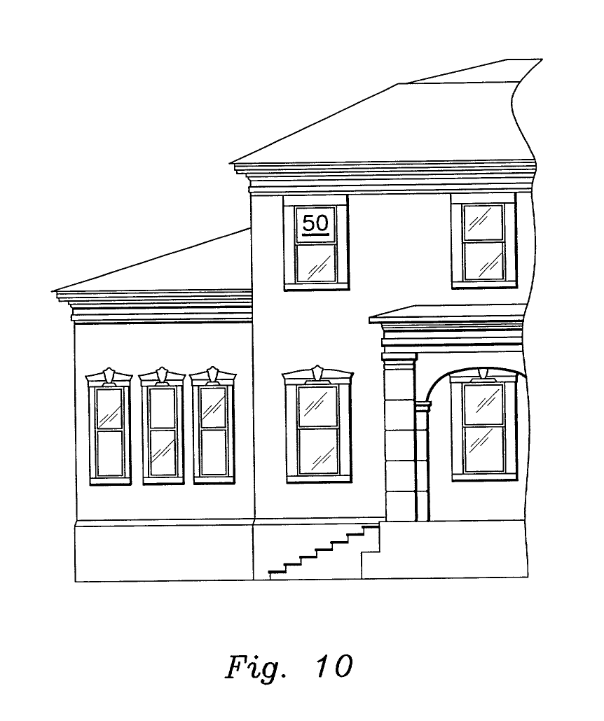

Architectural details are shown in FIGS. 4, 5 and 10 for an exterior window 50. The casing for the window 50 is built onto special blocks set as shown in FIG. 11 among the remaining framework.

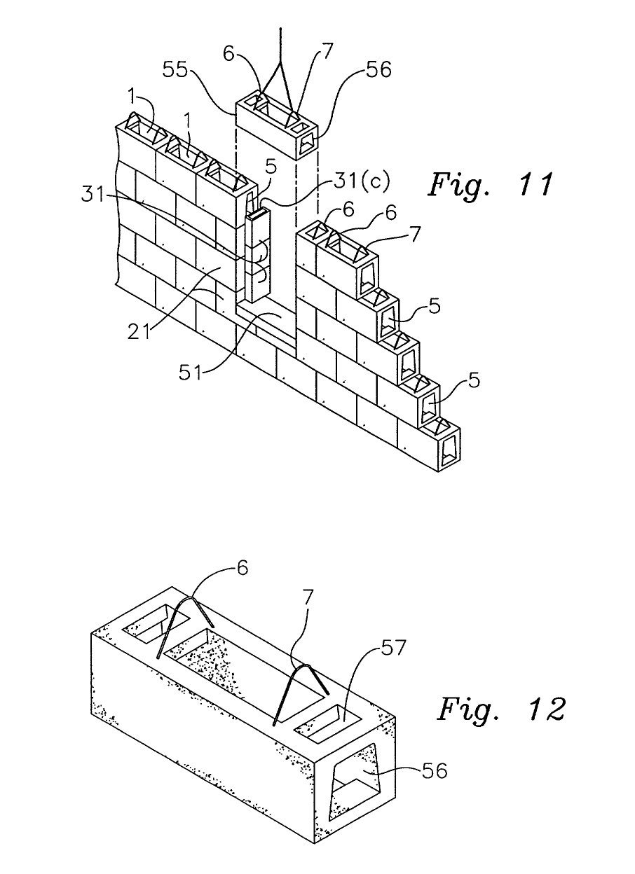

FIG. 11 shows how a window treatment described in FIGS. 4 and 5 would be assembled with a lintel 55 which, here, has neither a special exterior treatment nor a plate. Here, the 8-inch [0.203 m] frame blocks 31 are in place and the lintel 55 is being lowered by way of the support rods 6 and 7. A side opening 56 in the lintel may allow concrete to connect the lintel 55 to the 16 inch (0.406 m) blocks on either side which would have cooperating openings. The lintel 55 may also have bottom openings (not shown) to allow concrete coming into the lintel's interior through lintel top openings 57 (shown in FIG. 12) or side openings 56 to move into the top openings in the top most 8-inch [0.203 m] frame block. From there, the concrete would pass into the lower 8-inch [0.203 m] frame blocks sealing the structure together. Alternatively, after concrete has been poured into the 8-inch [0.203 m] frame blocks, the lintel 55 may be placed on top.

As the lintel 55 shows in FIG. 12 and 11, there may be multiple top openings 57 to allow pours down the left and right 8-inch [0.203 m] frame blocks 31. Similarly, there would be corresponding multiple bottom openings 4 (not shown) to allow the concrete to flow through to top openings in the 8-inch [0.203 m] frame blocks 31 below the top openings 57.

FIG. 12 shows a detailed view of the lintel 55 shown in FIG. 11.

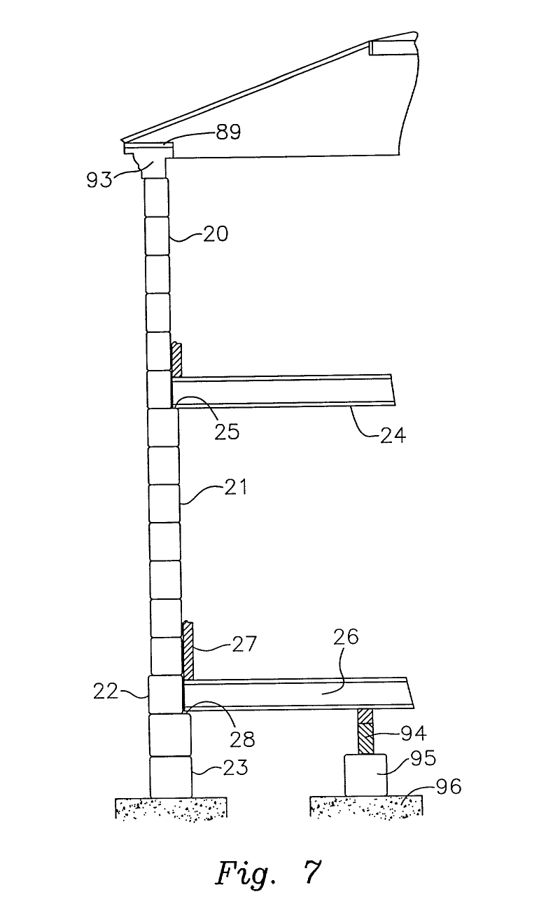

FIG. 7 shows a side cross section of a house where a series of blocks as shown in FIG. 1 are stacked one on top of the other and as can be seen here 12-inch [0.305 m] small blocks 20 may have holes bottom holes in alignment, not only with each other, but also with 16-inch [0.406 m] structural blocks 21 by virtue of having the location of the plug off center during their formation in order to allow for the placement of ajoist 24 on a plate 25 atop the 16-inch [0.406 m] structural block 21. This plate 25 is the area the larger 16-inch [0.406 m] structural blocks 21 which is not covered by the smaller 12-inch [0.305 m] small blocks 20. This is compared with the formed plate 25 which is an integral part of the top block 55 shown in FIG. 4(a).

A similar arrangement as present where 16-inch [0.406 m] structural blocks 21 are aligned with 18-inch [0.457 m] middle blocks 22 to allow for two by four wall lumber 27 to be run off of a sixteen inch [0.406 m] I-Joist 26 which in turn rests on a plate 28 which is the uncovered area of the 22-inch [0.559 m] bottom block 23 when the 18-inch [0.457 m] middle block 22 is placed on the larger block as shown in FIG. 7. Similar to the offset of the 12-inch [0.305 m] small blocks, the 16-inch [0.406 m] structural blocks and 18-inch [0.457 m] middle blocks 22 may have bottom openings 4 which are offset so as to be aligned with the top openings on 22-inch [0.559 m] bottom blocks 23 and may define an offset 28 on which to place a joist 26 to support the construction within the walls so described. The purpose being to incorporate the architectural details into the blocks, rather than to attach these details at a latter point in time.

FIG. 4 also shows how the blocks may be built directly off of the foundation 96 or how a intermediary foundation block 95 may be placed on the foundation 96 which in turn supports seals 94.

FIG. 13 shows several blocks being stacked together utilizing the method taught hereunder, utilizing a crane (not shown) to lower blocks via a hook 84 and chain 85 attached to a small spacing beam 86 which is attached by two second hooks 87 and support chains 88 attached to the block support rods 6 and 7. It can be seen that the blocks may be offset to provide a more interwoven structural cross section.

FIG. 14 shows the wall of FIG. 13 with a top plate 89 where several of the lifting bars 6 and 7 have been removed. FIG. 14 shows the top treatment for a row of blocks, such as that shown in FIG. 13. In this case, a group of cornice blocks 93, of similar construction, but having built in architectural details (a decorative overhang here) is placed atop the row of twelve inch (0.305 m) blocks 20. Concrete may be poured through the openings in this top after the cornice support rods 6 and 7 are cut from the top of the cornice blocks. In this way, a flat surface is presented. Bolts may be set in the concrete pour and a top plate 89, of wood or metal, may be bolted to these bolts to allow for greater ease of building off of the cornice blocks 93.

The interior walls of the molds may be modified in order to provide enhanced architectural detail or to provide for anchor bolts for interior finishes. As can best be seen by reference to FIGS. 15 and 16, the interior surface 60 of the outside mold wall 66 defines block openings 62. These block openings 62 may receive brick facing 64 or may be left empty to give texture to the block exterior face 68, shown in FIG. 19. The interior surface 60 faces the outside surface of the exterior face 68 of a block 69 to be made within the mold. The end product is a block such as that shown in FIG. 19. Hence, a finish may be applied to the exterior blocks by virtue of embedding a finishing material through this method or by imparting a finished texture. While a brick texture is shown here, any number of different textures could be encompassed by this technique including a vinyl or wood type finish which may be painted to look more like the final finished product. The key being to either (a) embed the finish material within the block by putting it in the mold or (b) texture the exterior of the wall by having the finish on the interior wall of the mold. The finishing means is either an exterior texture or a plurality of finish pieces (here brick or wood studs) where the finish pieces have an exposed side and an embedded side where the embedded side is within the block itself so that the finish pieces are partially embedded within the block and partially exposed from the block.

As shown in FIG. 19, there may be a continuous wall formed with this brick pattern, joined, as shown here, by intermediary blocks 90 and cornered by a corner block 91. Gaps 92 have been left in this embodiment by the mold into which these intermediary blocks 90 may be fit.

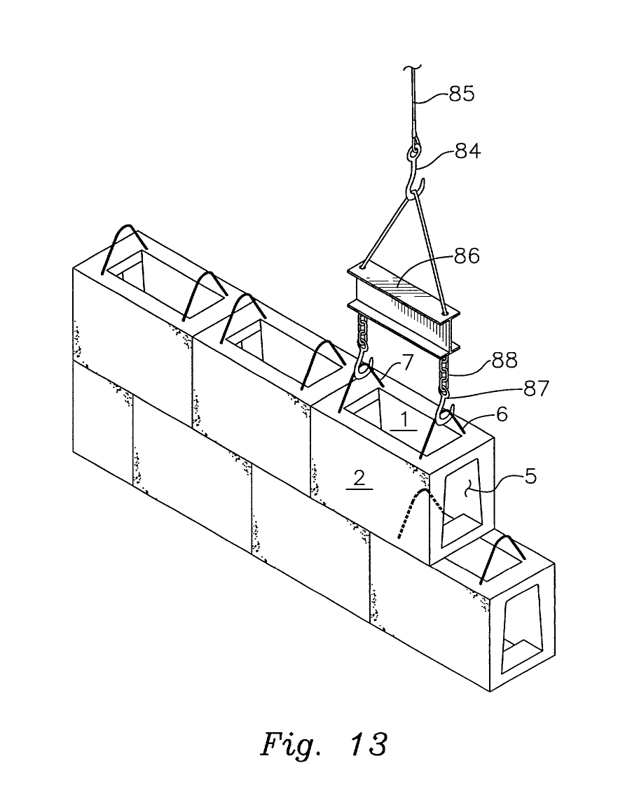

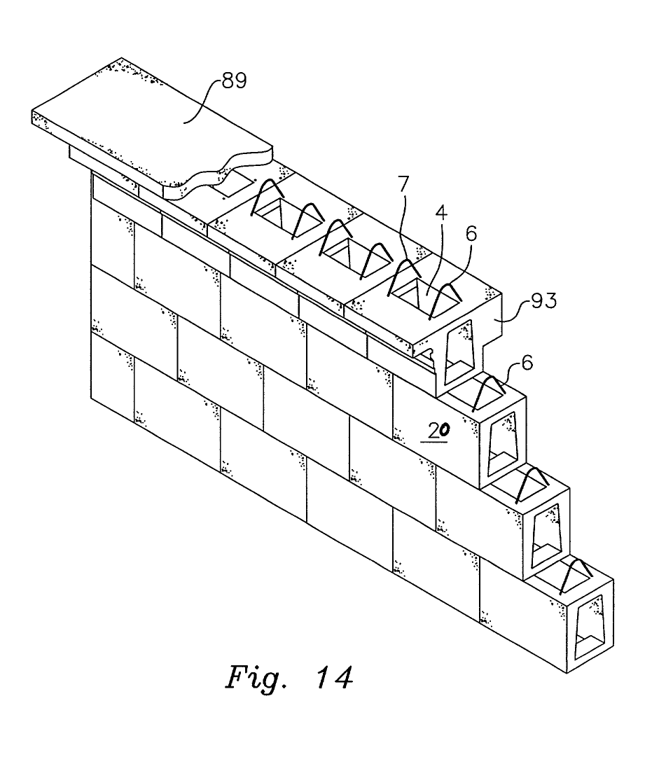

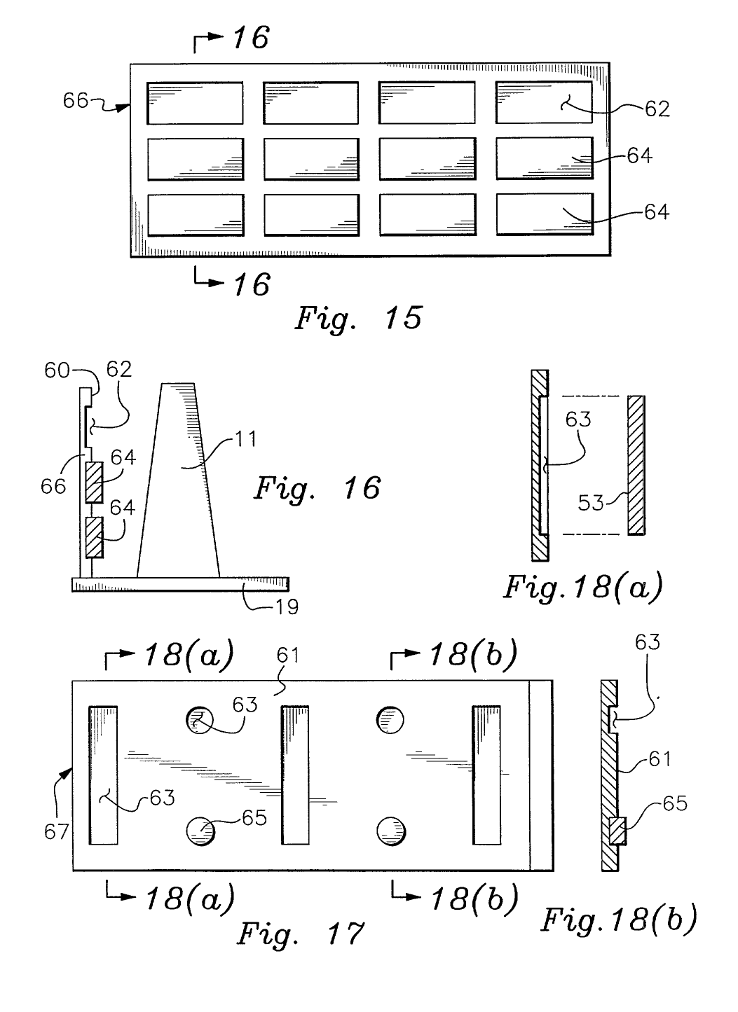

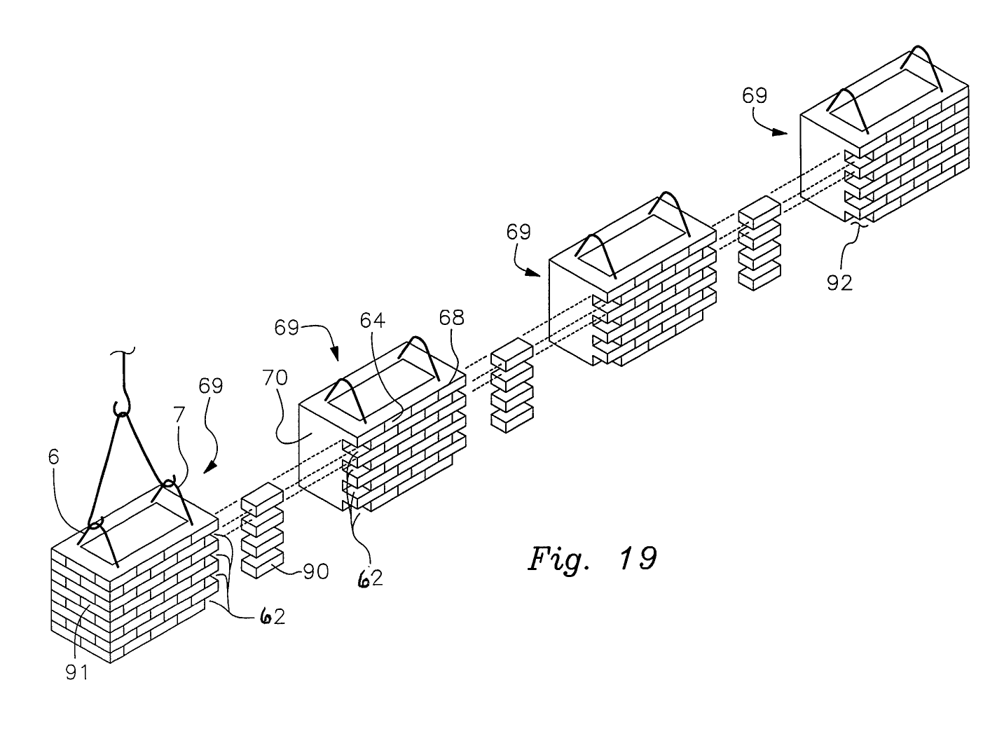

This same technique may be used, as shown in FIGS. 17 and 18a and 18b for attaching mounting studs 65. Mounting studs as used herein refers to wooden studs, wooden pegs, embedded nails or even bolts 65a, as shown in FIG. 4 within the concrete matrix for mounting a finish to the exterior or interior surfaces of the finished blocks. These mounting studs 65 are inserted within openings 63 at predetermined points on the interior surface 61 of the inner mold wall 67. The inner face 61 of the interior mold wall 67 corresponds to the interior face 70 of the block 2. It is the part of block 2 which faces the interior of the building and where studs are attached. As shown in FIG. 18(a), full length studs may be used which could be aligned with studs in the block below. As shown in FIG. 18(b) the studs 65 or bolts 65(a) (as shown in FIG. 4) may be much smaller and less obtrusive. The bolts 65(a) may be replaced with nails and may be set against a plate of wood or metal to cushion a blow which would be received when the interior wall is attached. It is also taught that the exterior treatment may be attached to similarly placed studs on this exterior surface were that desirable merely by having an exterior mold wall which was constructed in the manner taught hereunder for interior mold walls.

Since the arrangement, depth, shape and number of the openings 63 may be varied in an infinite variety, an infinite variety of finishes may be given to the exterior of the concrete where studs or bricks are not placed within these openings 63 or where different finishing materials are placed within these openings 63.

As shown in FIG. 4, the wide portion of the retaining bolt 65a which is embedded within the concrete when the block is poured may be wider than the exposed end. This is also true if mounting studs 65 are used. While here the mounting studs 65 are round, they may be of any shape and may extend any length along the blocks. In this way, the mounting blocks 65 may extend down the block and join with the next lower blocks mounting studs to form a continuous stud for mounting interior or exterior wall treatments (sheet rock, brick, etc.). An example of this is shown in FIG. 4 where a wooden stud is attached by way of a bolt into the brick. If the stud was instead incorporated into the poured mold, the same effect would be realized.

During the concrete mixing stage, the concrete or the concrete which makes the facade may be mixed with a concrete dye to give it the appearance of stone or to enhance its appearance as brick. Hence architectural details may be a brick facade designed into the mold or it may be a cornice 93 or window treatment 72 such as is shown in FIG. 14 and FIG. 4(a), respectively.

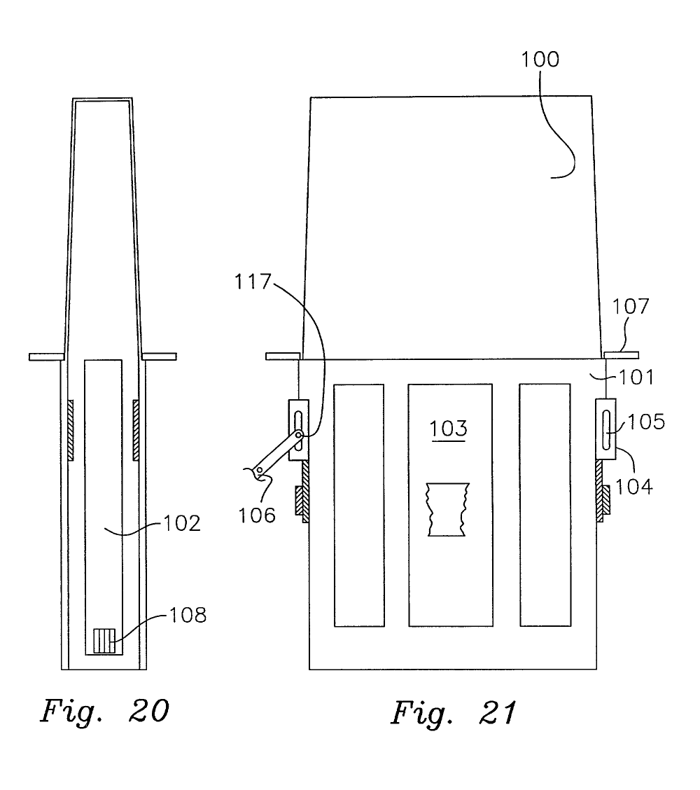

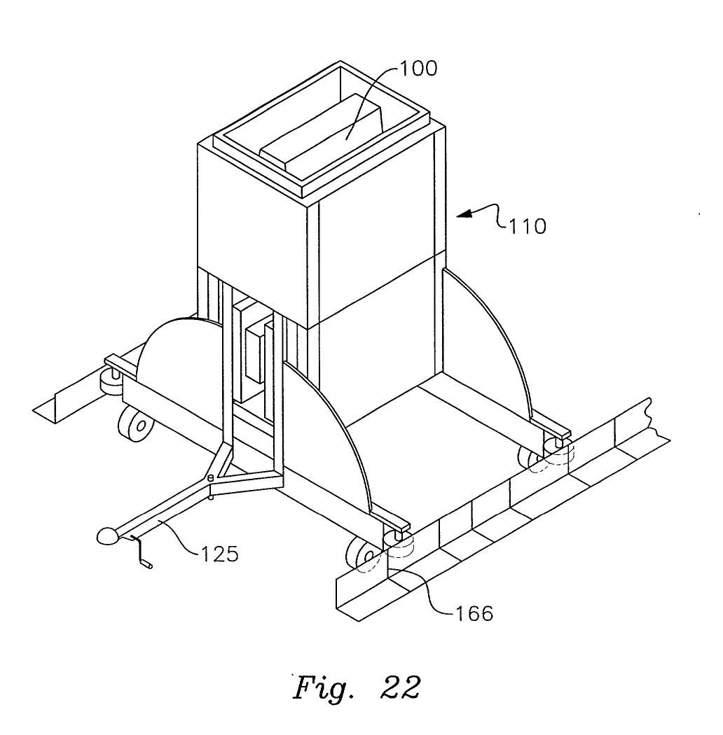

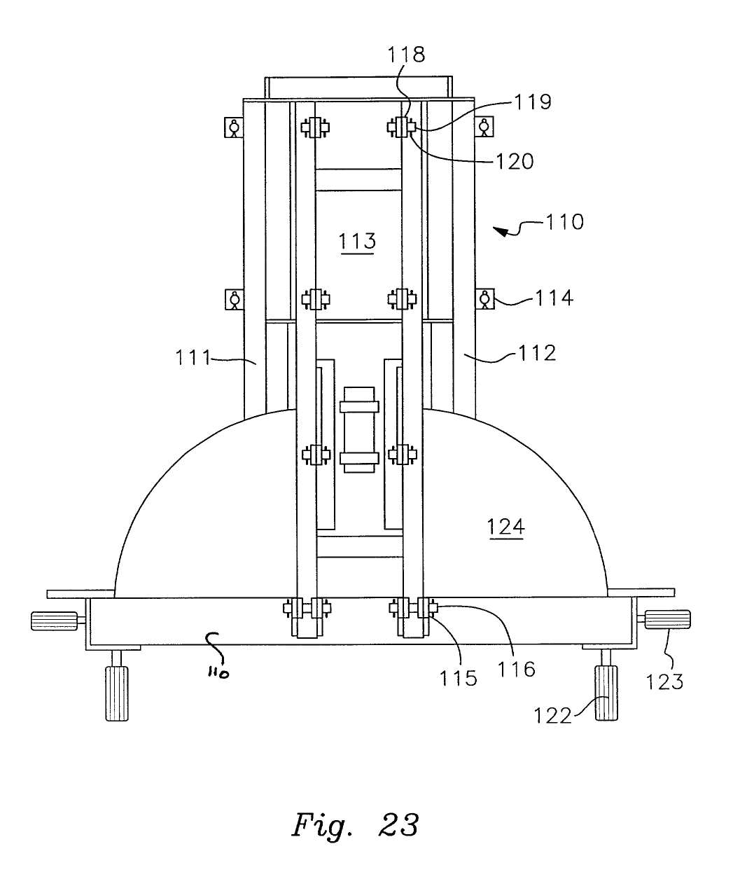

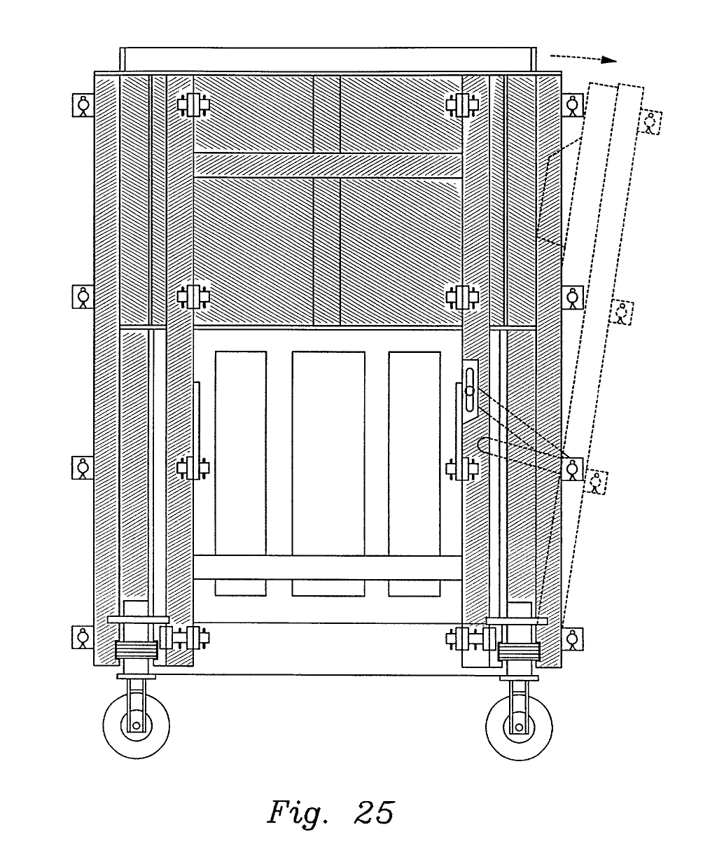

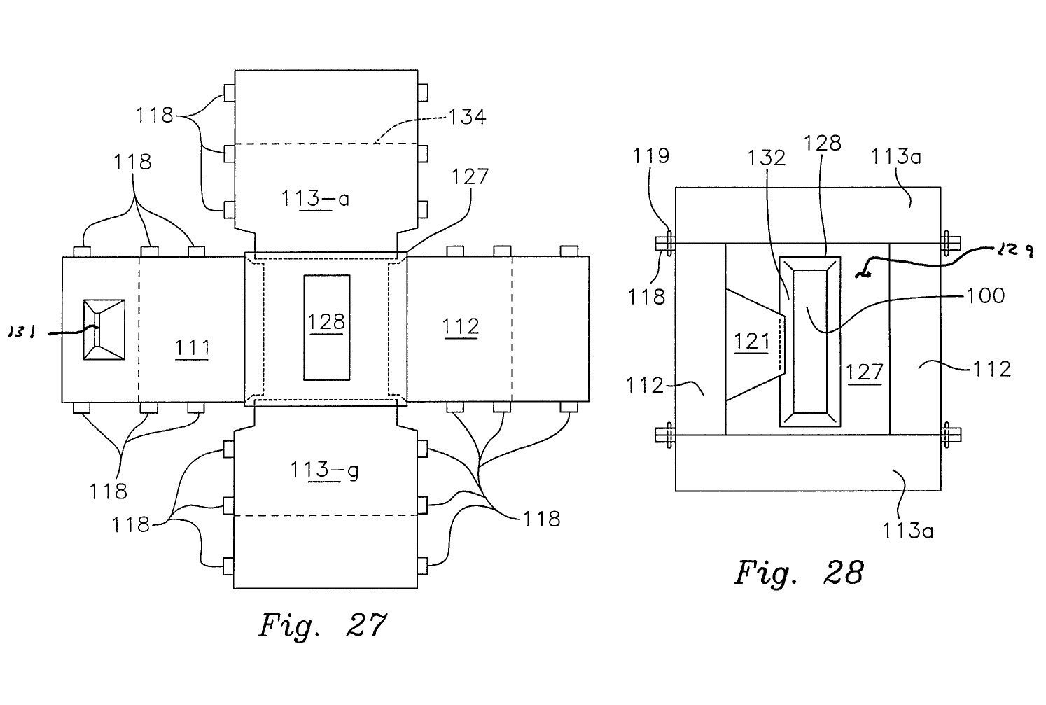

FIGS. 20 through 26 show block molds and a system for utilizing the block molds for producing blocks. As shown in FIGS. 27 and 28, the walls or plates 111, 112, 113a and 113b of the mold unfold like a flower petal to release a molded block and fold up together to form a concrete sealed chamber 129 when it is time to pour the next block.

Referring to FIG. 23, it can be seen that each of the plates 111, 112, 113a and 113b are connected to a central rack 110 by a pivot defined by pin 116 through a opening in a bracket 114 attached to the bottom of the central rack 110 so that the plates fold out from the bottom of the central rack 110. As seen in FIG. 27, the plates may have reduced bottoms 133 so that they can fold out without interfering with one another. While FIG. 27 shows the plates unfolded completely, this amount of unfolding would not be accomplished in the preferred embodiment. They would only fold out enough to disengage from the formed concrete block and to remove the plugs from the concrete block.

Referring again to FIGS. 27 and 28, the rack defines a rack bottom 127 and a plug opening 128 to receive the plug 100 in the rack bottom 127. The four plates extend above the rack bottom 127 a sufficient distance (here represented by the dotted line 134 on FIG. 27) to define a block mold of desired size. Plate 112 in FIGS. 27 and 28 defines a side plug 121 having a contact face 131 which contact face rests against the plug receiving face 132 of the plug 100 so that a passage is formed within the block after the concrete is poured. The plug 100 serves as the mounting plug for the internal cage 3 which is not shown on these Figures.

One or more plate connecting brackets 118 are held together by pins 119 when the plates are folded together so that the mold is secure. These same brackets 118 can be used to pull apart the mold if necessary.

The four walls or plates are designed in such a way that when the four walls are folded against the rack, they form an enclosure or chamber 129 having an open top for receiving concrete poured to form the block.

The sides of one or more of the plates 111, 112, 113a, and 113b may define a side plug 121 designed to fit snugly against the central plug 100 received by the opening 128 in the rack 127 and typically has recessing sides or sloping walls to allow the side walls to pull down without having the plug 121 push against the molded concrete. Central plug 100 is a part of a plug stand 101 which defines a post, hook or an eye bolt whose use is described in more detail below.

As can be seen through the use of a multiplicity of side plates, a variety of openings and outward block textures may be achieved using this process. While FIGS. 27 and 28 only show a single side plug 121, more plugs may be used and even multiple side plugs on a single plate to obtain various effects.

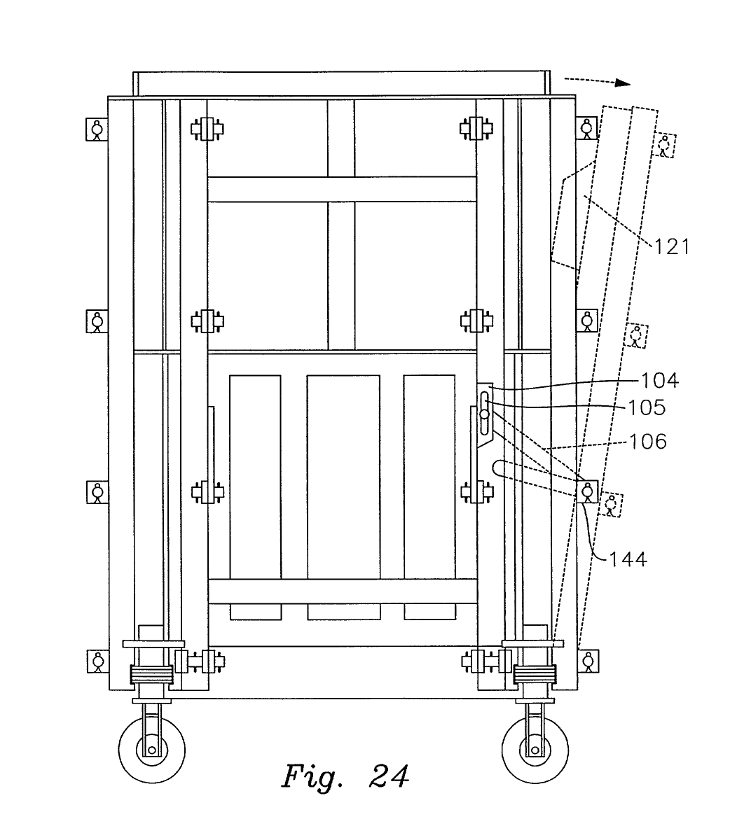

Each of the wall plates, 111, 112, 113a and 113b are also secured to the bottom of the rack 110 at pivot 115 by way of a pin 116. This pivot 115 allows the walls to fold outward as discussed with reference to FIGS. 27 and 28. A lever arm 106 attaches to the central plug stand 101 by way of a slotted bracket 104 describing a slot 105 into which a pin 117 fits slidably. The other end of the lever arm 106 is attachable to a wall plate (111, 112, 113a, 113b). Each of the wall plates is preferably connected to a slotted bracket 104 attached to the plug stand 101 as shown on FIG. 24.

In use, the block mold is made by assembling the four walls (111, 112, 113a, 113b) so that they form an enclosure with the appropriate plug within the plug opening 128.

Concrete is then poured into the unit and allowed to cure to the desired consistency.

Thereafter a rod or chain (not shown) is inserted over the I-Beam receiving beam 108 which is a part of the plug stand 101. This chain is connected to a spring loaded piston.

The spring provides a jolt to bump down a distance less than the length of the slot 105 and preferably between a quarter of an inch (6.35 mm) and ten inches (0.254 m).

Then the piston pulls the block the remainder of the way down. This sudden jolt helps to disconnect the central plug 100. A more gradual force is usually sufficient to separate the side wall plates, although a second jolt may be provided for this purpose. The slots 105 are provided so the initial jolt is not transmitted to the side plates and the attached plug 121.

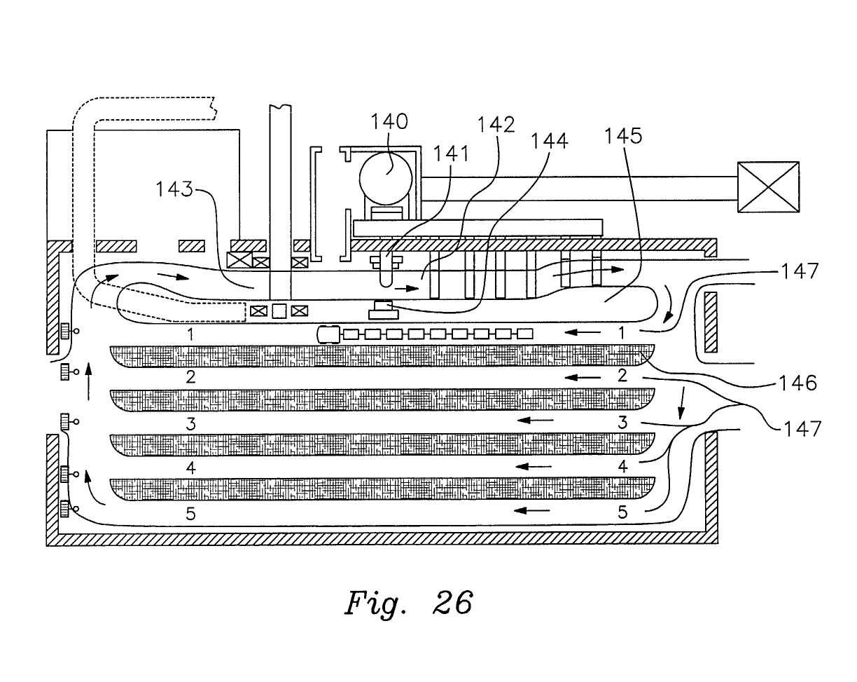

The entire system is preferably mounted by way of wheels 122 on the main rack 110 so that this device may be wheeled underneath the auger chute 141 shown in FIG. 26 for the concrete to be poured or over the chain engaged to the spring loaded piston 144 for separation or along the troweling stations 145 where the concrete can be smoothed.

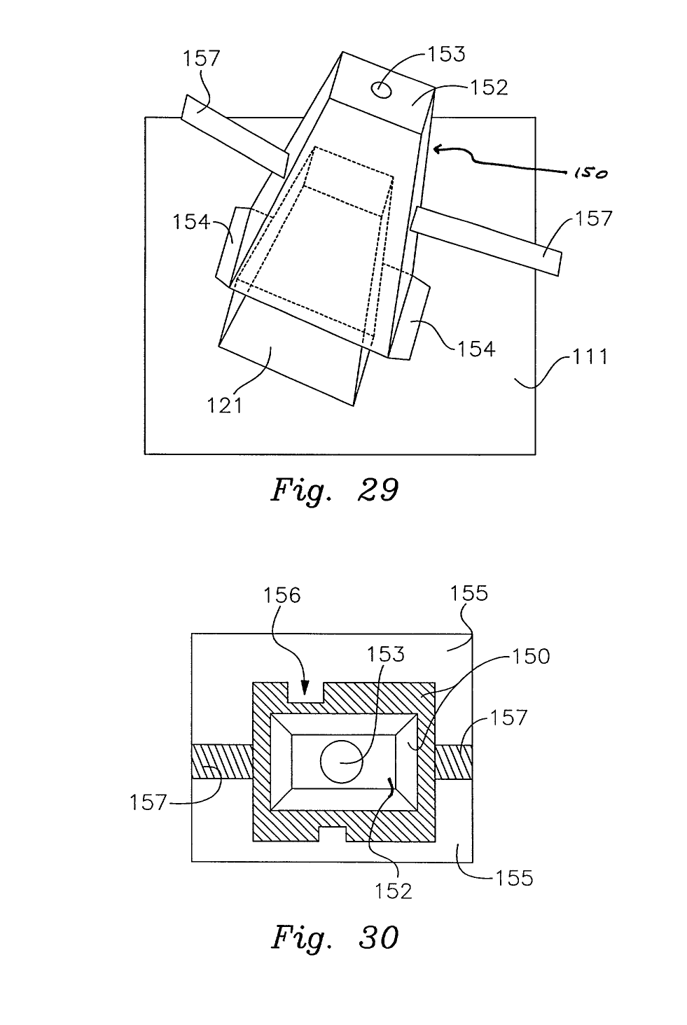

Another improvement in the molding process is the preparation of the mold where the mold plugs and side walls may be coated with cloth, wax or oil to reduce the amount of force necessary to separate the plates or plugs or walls from the blocks.

Where oils or waxes are insufficient, a coating which becomes a part of the block may be used. Another improvement, therefore, of the device is to have a appropriate material, such as plastic foam, fashioned into a cover or corel 50, as shown in FIG. 29, which has an open bottom 151 which may fit over the plugs 100 or 121 before the block is poured. This core 150 becomes a part of the block and pulls off of the plug or wall or plate in order to allow the plug to more easily be separated from the wall or plug of the mold. The core 150 may also cover all or part of the surface of the plates (such as 111) as well as the plugs 100 or 121.

The width and size of these plastic foam cores 150 may vary and may have openings where the plugs 100 and 121 would leave openings 153 at the top. The foam may set against a steel plug or one foam core may sit against another foam core to provide a seal. While the opening 153 in the top 152 of the plastic foam core 150 is shown partially cut in FIG. 29, it may be of any size.

The plug cover 150 may be made of a variety of materials, plastic foam, plastic sheeting, paper, fiberglass, cardboard, paper mache, sheet rock or other suitable material, even a chemical coating such as a thick layer of oil or wax. If not a viscous substance in it's entirety, the cover 150 may be coated with wax or oil or other material.

Bottom flaps 154 are shown on the sides of the cover 150. These flaps 154 would provide an exterior for the blocks. This is similar to the concept of providing textured exteriors 64, as shown in FIGS. 16-18. These exteriors would be held in place to a superior degree by virtue of being a portion of the embedded core 150. The flaps 154 or other exterior coatings 64, could cover the entire outside of the block so that an interior sheet rock or plastic foam wall is exposed.

Middle flaps 157 may also be provided which would form a vapor seal, if moisture proof materials are used as shown in FIG. 30 between the outside and inside of a block.

A superior fixing of the covers 150 within the poured block may be accomplished, as shown in FIG. 30 which is a cross section of a block showing the foam core, by having indented areas 156 in the cover, here corel 50. The indented areas 156 fill with concrete. FIG. 30 shows the concrete 155, the core 150 and the top 152 of the core 150 along with the opening 153 for the passage of concrete poured after the block is in place.

The procedure for making blocks, shown in FIG. 26, using buggies comprises the steps of (1) preparing the buggy, by (a) selecting the appropriate sized buggy, (b) attaching the proper plates with the appropriate side plugs, (c) adding a bottom plug, if necessary, (d) attaching the lever arms to the plates so that they may be pulled apart, (e) coating the interior surfaces of the plates and the plugs or inserting covers over the plugs, (f) adding any finishing materials to the plates (which may be done before putting the plates in place), and (g) hooking the buggy by way of pull bars 125 to a motorized cart or another buggy in line, (2) mixing concrete, (3) placing the buggy under the augur chute, (4) pouring concrete into the mold, (5) troweling the concrete, (6) curing the concrete, (7) moving the buggy over the spring loaded piston, (8) jolting the bottom plug, (9) pulling apart the side plates and pulling down the bottom plug, (10) moving the finished block by way of a crane to a loading area.

‘Streets’ 147 separated by built up walkways 146 serve to guide by way of caster guide wheels 123 the carts along the process.

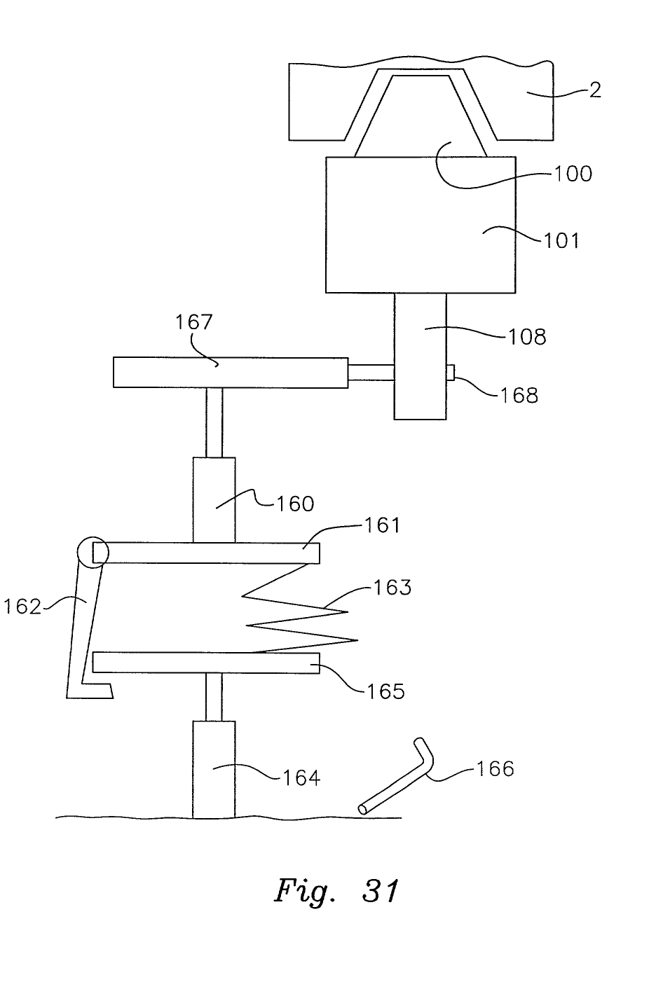

As shown in FIG. 31 the spring loaded piston comprises a piston 160 mounted on a plate 161. A spring 163 pulls downward against the plate 161, but a latch 162 prevents the spring from pulling the plate 160 downward. To tension the spring 163, a second piston 164 pushes the second plate 165 against the spring 163. This second piston 164 may retract leaving only the latch 162 preventing the spring from acting. When the latch 162 is released, the sudden action of the spring pulls the plate 161 suddenly downward. The plate 161 pulls down the plug 100 with a jolt as described above, using a third piston 167 which has an arm 168 which catches and pulls down the receiving beam 108 to provide the jolting action. The receiving beam 108 may define an opening to receive this arm 168.

A second latch 166 may hold down the plate 161 while the piston 160 pulls the plug 100 out from the block 2 while also pulling away the plates 111, 112, 113a and 113b in the manner described above.

The length of the arm of the second lower piston is such that it cannot over tension the spring.

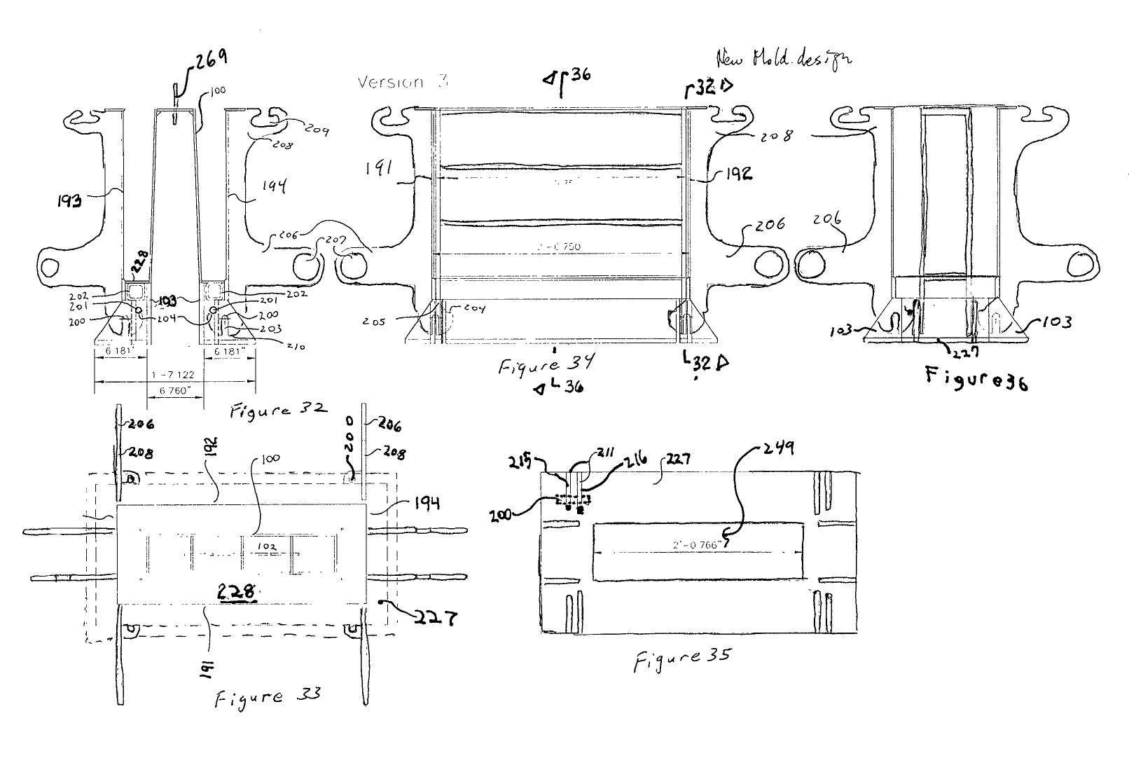

FIGS. 32-35 show a mold system for constructing concrete blocks by pouring concrete into an assembled mold and wherein said blocks have at least one internal opening comprising:

a) a plurality of floor plates 227 for forming the floor of the block molds. These floor plates 227 receive in slots 211 the bottom of the plug base brackets 103. There is an outside slot 215 and an inside slot 216 for receiving a plug base brackets 103 between which the pivot 200 runs. These two brackets and pivot 200 may be made as a single piece and bolted or welded or screwed or otherwise attached to plate 227.

b) a carrying means, here the stand made of beams 202 for holding the mold base 228 is located below and in contact with the mold base 228 above the floor plate 227 so that when the rods 201 are rotated upward in contact with the beam 202, the mold base 228 can be lifted slightly to dislodge the completed block from the mold;

c) a plurality of panels or walls forming the left wall 191, right wall 192, top wall 193, and bottom wall 194 of an enclosure for receiving concrete are attachable at their bottom to the pivots 200 and along their length they contact the mold base 228 to form an enclosure with the mold base 228 being the bottom and the walls 191, 192, 193 and 194 forming the walls of the mold and shaping the walls of the blocks formed in the wall. As can be seen by reference to FIG. 37a, the inside wall of the walls 191, 192, 193 and 194 may have a floor joining portions 217 which serves to seal the mold and a slightly less thick block wall shaping section 218 running along it's length to ensure a good seal and a proper shaped block. As described in the embodiments of FIG. 52, these walls 191, 192, 193 and 194 may also have plugs (shown as 16 and 16a in FIG. 52) built in to ensure the appropriate flow of concrete as discussed above in the finished blocks. As shown in FIGS. 53a and 53b, the assembled molds may be placed on;

d) at least one platform 220;

e) a carrying means, here wheels 122 on axles 123 for moving the platform 220 and;

The mold wall system can be described as f) at least one wall receiving means for joining at least one of the plurality of walls 191, 192, 193 and 194 to at least one of the plurality of base members 228. Except in cases where no plug in the bottom is desired, there is g) at least one plug 100 attachable to at least one of the plurality of walls or base 228 for defining an internal opening within the block to be formed; and

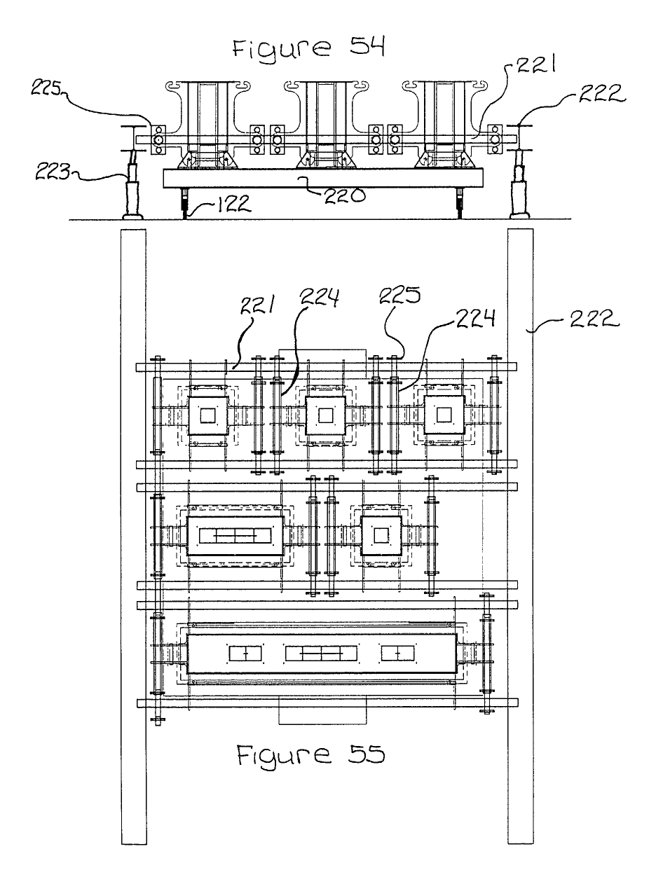

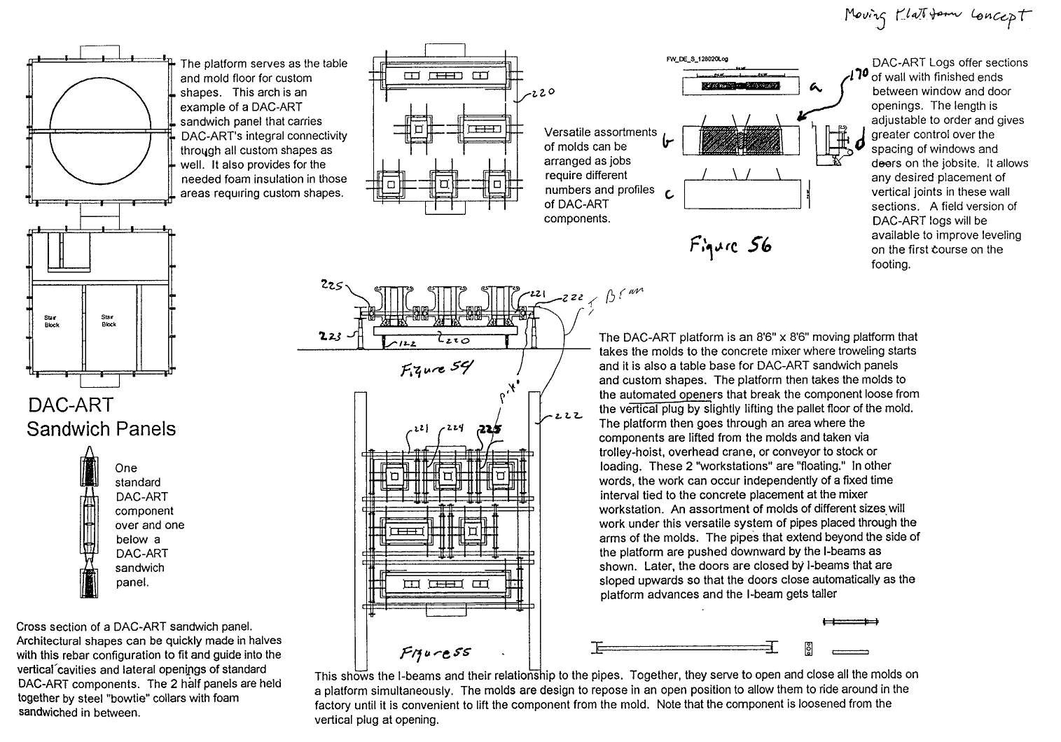

h) a separating means for mechanically separating the walls and the base from concrete added to the mold, here a vertical pipe 221 or horizontal pipe 224 fitting through bottom wing holes 207 in the bottom wings 206 of the walls which are aligned horizontally or vertically and which are pulled downward by an I-Beam 222. As shown in FIGS. 54 and 55, the horizontal 224 and vertical pipes 221 may be interconnected to have several pulled down simultaneously by one or more I-beams 222 which would preferably move together.

The unique mold manufacturing technique described above allows for a plurality of floor plates 227 corresponding to the different size blocks to be produced to receive the plug base brackets 103 at the base bottom by way of a plurality of slots 211 in edge of the floor plates 227. Slots 211 hold an inside base in an inside slot 216 and an outside base in an outside slot 215 which may hold between them a pivot 200. This pivot 200 is nothing more than a metal cylinder. For each base so constructed, a bottom fitting 210 (which is an integral part of the walls 111, 112, 113a and 113b) is inserted onto the pivot means 200 for supporting the wall (191, 192, 193 and 194) so that the wall may be rotated to contact the mold base 228 to form the enclosure needed to form blocks. The plug base brackets 103 are supported within the slots 211 as discussed above, but may easily be knocked out when needed with another floor plate.

As can be seen by reference to FIG. 32 and 37a-c, the walls (191, 192, 193 and 194) comprise a bottom fitting 210 pivotably attachable onto the pivot 201, said bottom fitting defining a slanting wall 205 ending in a floor 204 offset from the pivot 200 above the floor plate 227 and under one of the plurality of beams 202 which support the mold base 228 in an assembled mold. A rod 201 ensures that the pressure exerted by the rotating bottom fittings 210 and floor 204 push up along the length of the beams 202 when the mold is being opened in the embodiment shown in FIG. 32. As shown in FIG. 37, these rods 201 are not present until the mold is assembled to allow the walls to be easily inserted over the pivots 200.

The walls further comprise at least one wing 206 offset from the pivot 201 opposite the offset of the floor 204 defining a connecting means for connecting the wall to the separating means. The connecting means, as shown in FIGS. 55 and 54, comprise vertical and horizontal pipes 221 and 224, respectively inserted through the holes 207 in the wings 206, which may be connected by securing plates 225 to one another. A jack 223 may be provided to pull an I-beam 222 downward (or upward where appropriate) to open and close the mold and push the floor out of contact with the plug and pull the walls apart as can be seen from the movement associated between the walls and the offsets of the pivot 200 described above.

Because FIG. 32 is a cross section through the mold directly before one of the plug base brackets 103, it does not show the floor 227. FIG. 36 shows the mold of FIG. 32 from a position from the center where the floor 227 can be seen.

FIG. 33 shows the mold of FIG. 32 from a top view.

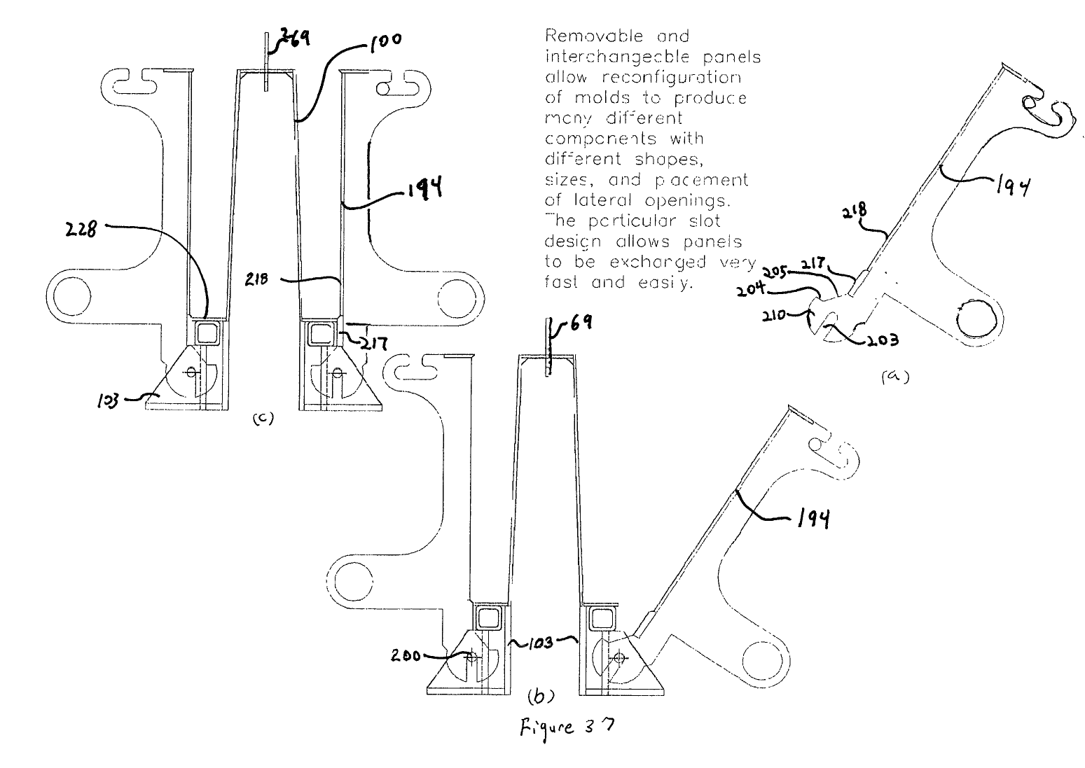

FIG. 34 shows the mold of FIG. 32 from a side view.

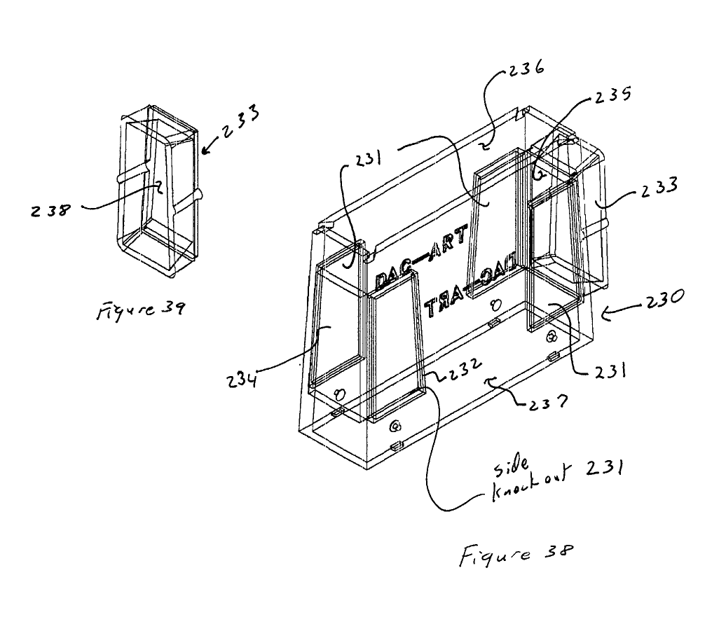

FIG. 35 shows floor 227 of the mold which forms the base shown in FIG. 32. The opening 249 in the floor 227 may hold a plug support but is not used here.

FIG. 36 shows the mold of FIG. 32 from a position from the center where the floor 227 can be seen.

FIG. 37a-c shows the attachment and movement of a mold wall when being connected to the mold in three steps (a) the wall separated, (b) the wall attached but open (here with the rod 201 removed so the floor is not affected) and (c) with the mold assembled without the lifting rod 201.

FIG. 38 shows a modified plug 230 (which works like the plug 100) with an attached side plug with punch outs. As can be seen by reference to FIG. 38 the cover plug 230 comprises side knockouts 231 held onto the plug 230 by weakened edges 232 around the perimeter of the knockouts 231. Also there are end knockouts 234. When a knockout is removed, a side plug 233 or side core 16 may form a continuous chamber with the chamber formed by the plug 230 in the finished block. In FIG. 38, a side plug cover 233 is shown which will cover a side plug to form the continuous chamber as described in more detail below. In this embodiment, the top 236 of the plug cover 230 is open as is the bottom 237.

In this view, there is an opening 235 left by the removal of an end knockout 234 which is not shown since it is removed.

FIG. 39 shows the side plug cover 233 from FIG. 38 showing the open area 238 defined by the side plug cover 233.

FIG. 40 shows a top view of the plug from FIG. 38.

FIG. 40a shows a cross section of the plug from FIG. 40 through the b-b section.

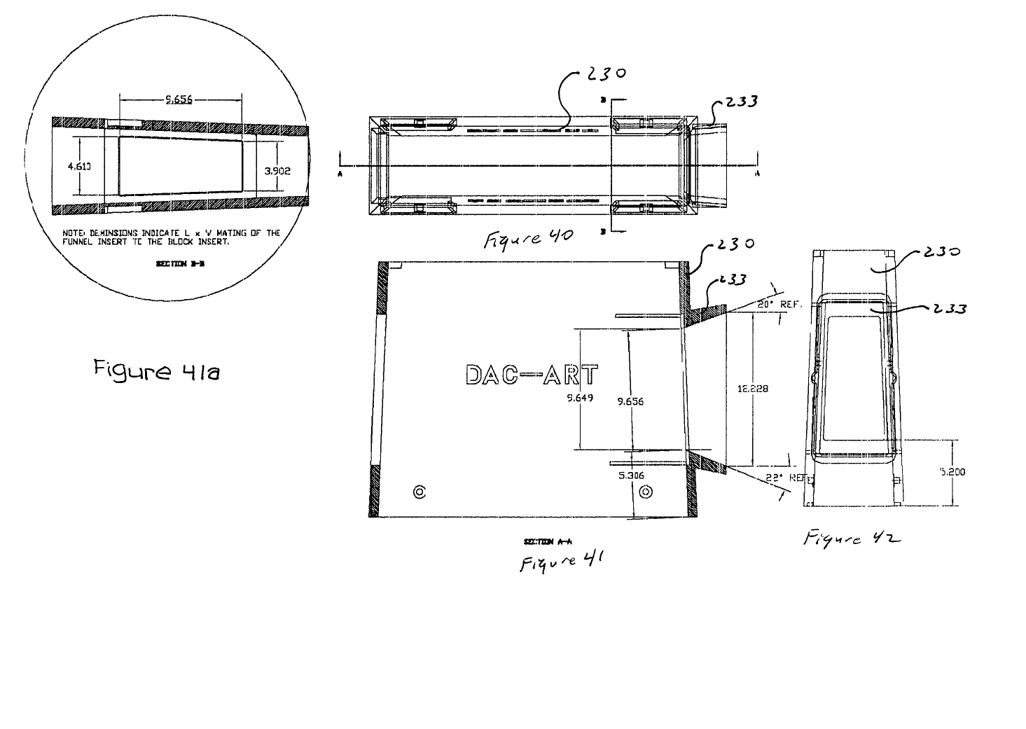

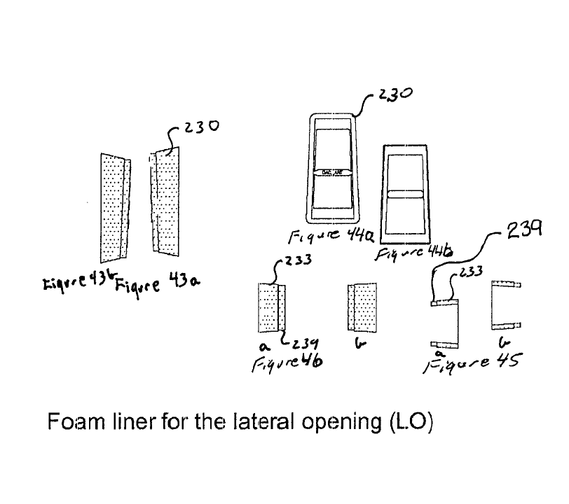

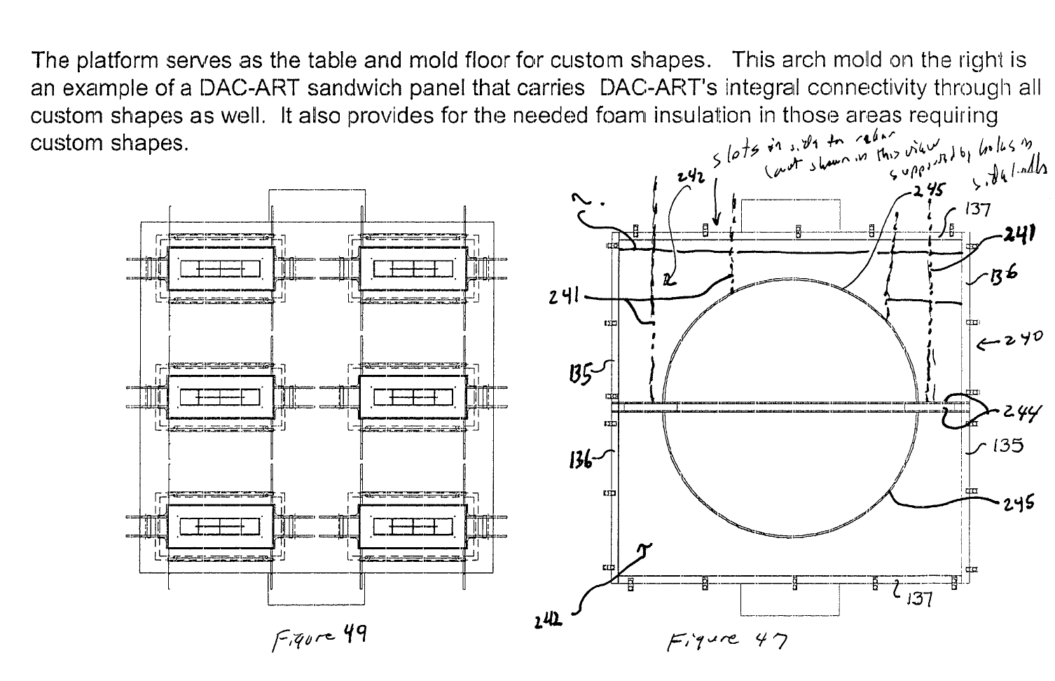

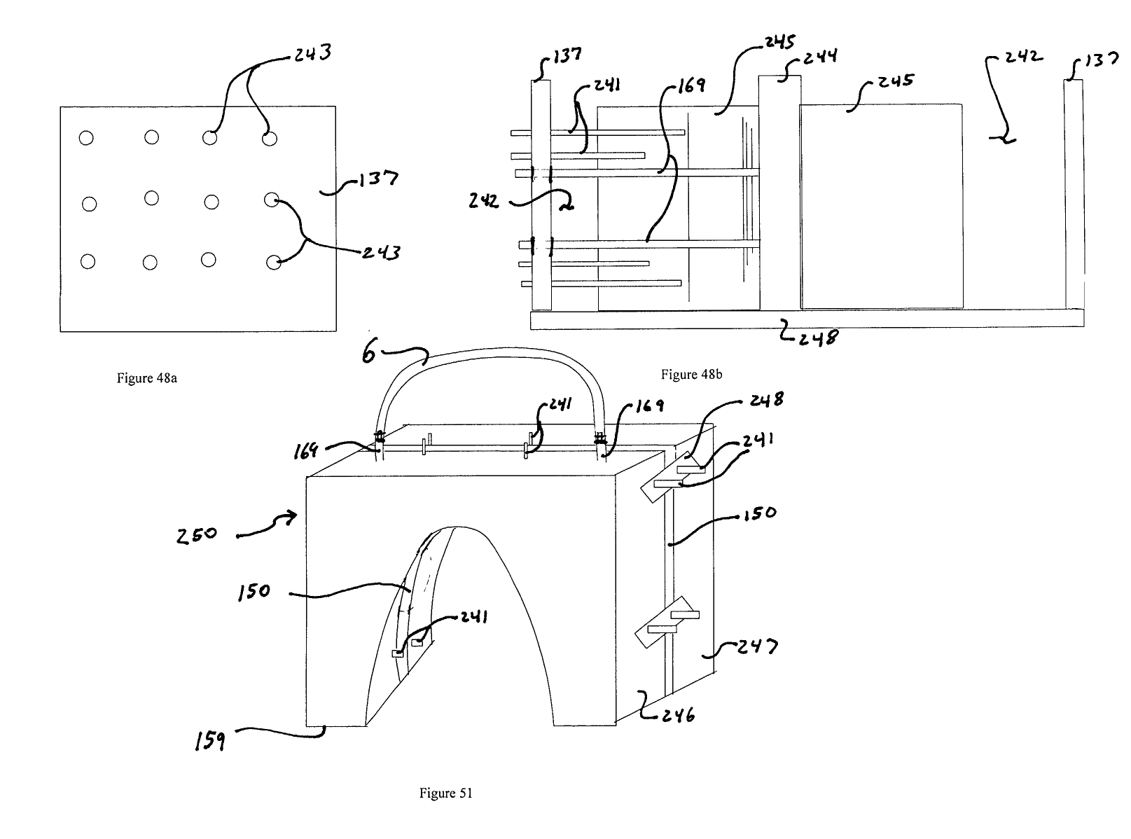

FIG. 41 shows a cross sectional side view (a-a section) of the plug from FIG. 38 with the side punch outs removed.

FIG. 41 a shows a cross section through the b-b axis of FIG. 40.

FIG. 42 shows a side view of the plug of FIG. 38.

FIG. 43 shows an alternate side view from that of FIG. 42. FIGS. 43a and 43b show the two side views.

FIG. 44 shows the opposite side view from FIG. 43.

FIG. 45 shows a cross sectional view from FIG. 39. In this cross section, it can be seen that the end of the side plug cover has a reduced size lip 239 to allow it to be tightly inserted into the main plug cover 230.

FIG. 46 shows a side view of the side plug of FIG. 45.

FIG. 47 shows an alternate mold 240 designed for side rods 241 (all cage and rebar materials are typically ¼ inch (6.35 mm) re-bar) which are inserted through holes 243 (shown in FIG. 48) in the top wall 137, in the mold. Other rods may also be inserted through comparable holes which may be offset from the other holes described herein which comparable holes would be in the left 135 and right 136 walls. Here, two molds of this design have been joined to have a square mold sharing a common middle wall 244. The left and right side walls are reversed since the two joined molds are mirror images. As can be seen, there is at least one single curved plug 245 to give the desired shape to the manufactured block, here an arch. The use of this specialized block is described below in conjunction with the other blocks. The chamber 242 formed by the walls can be filled with concrete and the mold broken in any manner discussed in this case with the rods embedded in the finished block.

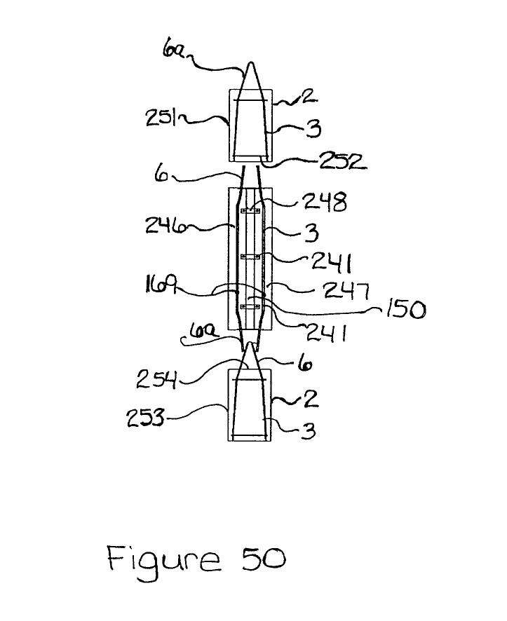

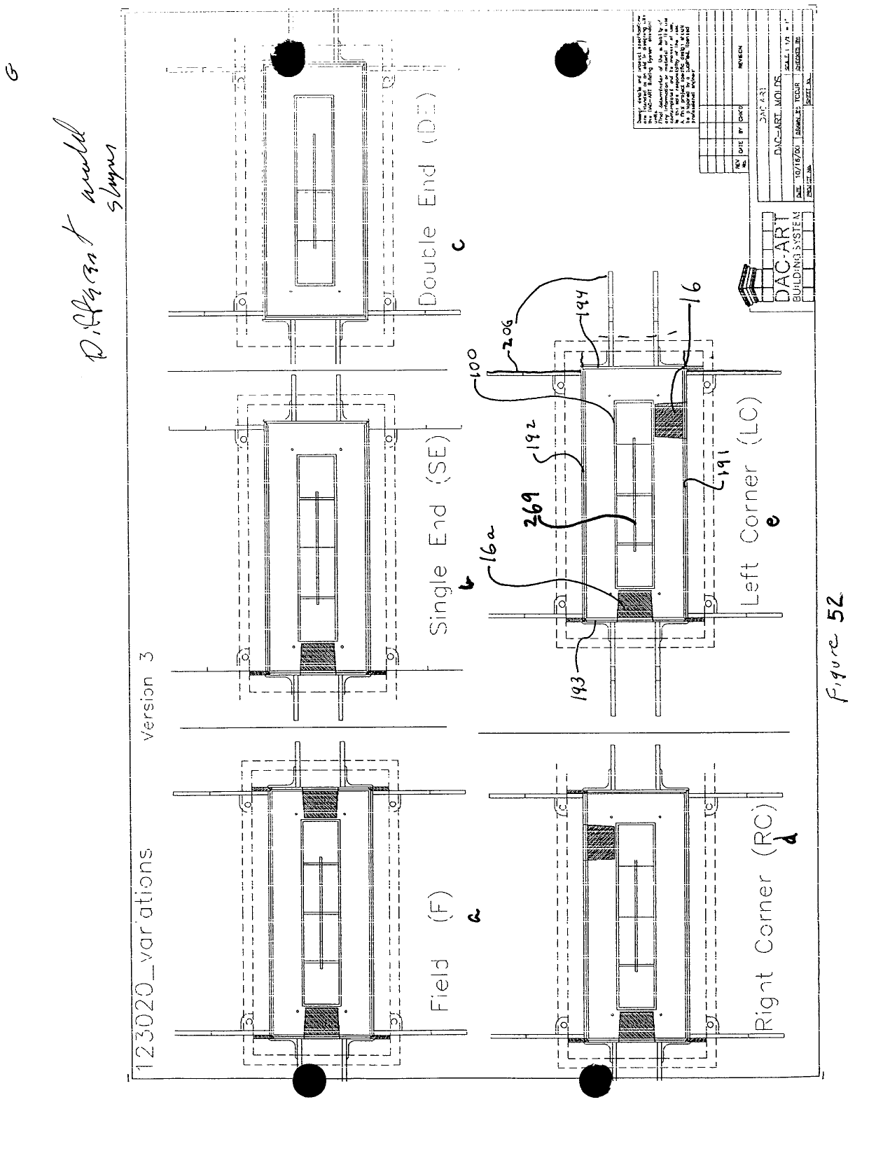

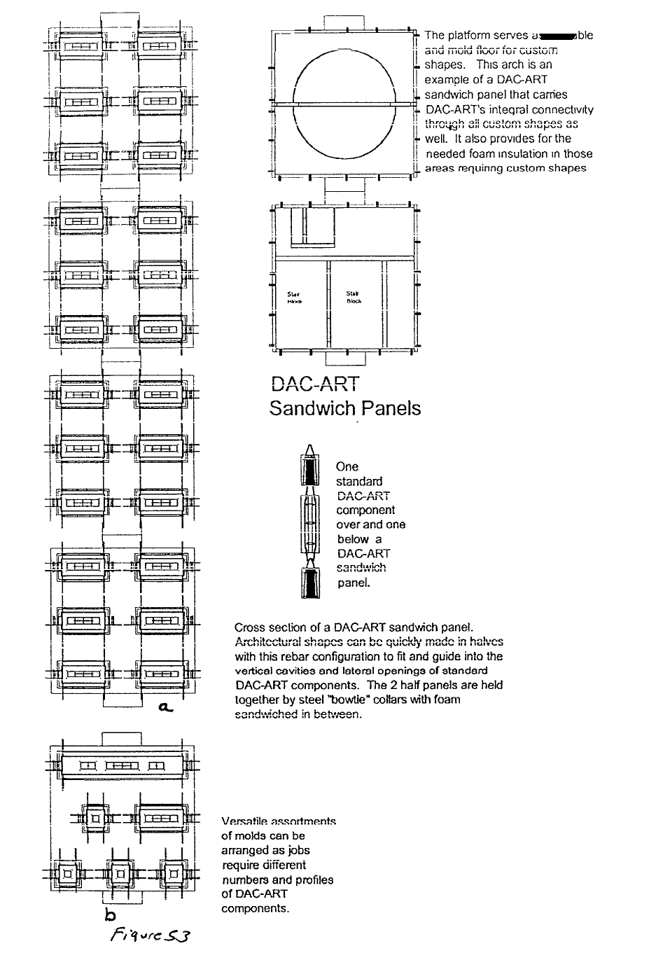

FIG. 48b shows a side view of the mold of FIG. 47 with the side wall 192 removed. As can be seen from this view, metal reinforcing side rods 241 of differing lengths have been inserted into holes 243 (see FIG. 48a) in wall 193. These side rods 241 contact the curved face of the curved plug 245. They may go through any of the mold walls 135, 136, and 137. The space 242 between the plug 245 and the base 228 and the side walls 191, 192, 193 and 194 forms the interior of the mold into which concrete may later be poured. The walls may be joined in the manner described above for the various mold types in order to allow for the mold to be opened. While wings 206 are not shown in FIG. 47, the same technique can be used to open the side walls 137, 135 and 136. The lifting rods 6 may be tied to or formed from special side rods 169 before or after the concrete is poured to form guide rods 6 and 6a, as shown in FIG. 50. FIG. 51 shows how these special side rods 169 stick out of the side wall 137 and the feet 159 when they are to form lifting rods at the top and bottom of the block 150.

The side rods 241 may be joined later with plates 248 as shown in FIG. 53 which shows a completed block 250. This block 250 may have a foam core 150 which is sandwiched between the two halves of the concrete block a left half 246 and right half 247. As is described earlier, the foam core 150 may be partially incorporated into the face of one of the blocks 246 or 247 (FIG. 16 shows an example).

FIG. 50 shows the use of the alternative block 250 from the alternate mold design described in to FIG. 47, 48a and 48b. As can be seen, the side rods 241 in the finished block 250 from the mold described in FIG. 47 have been tied into a cage 3 and come from the top and bottom to form rods 6 and 6a respectively. Rods 6 and 6a are insertable in this design within the bottom opening 252 of a top block 251 in the traditional blocks described in reference to FIG. 1 and within the top opening 254 in the bottom block 253 to maintain the desired continuity of design.

FIG. 51 shows a perspective view of the block showing where two such blocks have be enjoined by plates 248 welded between side rods 241 extending from two separate alternative blocks 246 a and 247 to form a continuous arch. FIG. 50 shows where the blocks have, in addition to the horizontal rods 241, vertical rods in the form of guide rods 6 and 6a which correspond to and work like the guide rods 6 of the blocks 2 as described in FIG. 1 herein.

FIG. 52a-52e shows alternative molds having different plug layouts. 52a (f) shows a field block mold layout for forming a cavity to either end. 52b (se) shows a mold with a plug on one end to open the block on a single end. 52c (de) is a mold for a block which only has a central opening and no open ends. 52d (rc) shows a right corner block having one end and one corner open and 52e (lc) shows a block like 52d with the opposite corner open.

FIG. 49 shows a plurality of molds on a platform 220 prior to being joined by horizontal and vertical pipes as described in more detail below. These molds have been aligned in a predetermined fashion for the purpose of joining them.

FIG. 53a and 53b show alternative platform layouts for blocks which are described in more detail below in the description of how the platform is completed.

FIG. 54 shows a side view of a loaded platform. This platform has been fully loaded with molds and has had vertical 221 and horizontal 224 pipes as described above attached to the molds wing openings 207. These are also shown aligned with I-beams 222 which are mounted onto jacks 223 so that the entire platform of molds can be simultaneously opened together as the jack 223 lowers.

FIG. 55 shows a top view of the platform from FIG. 54.

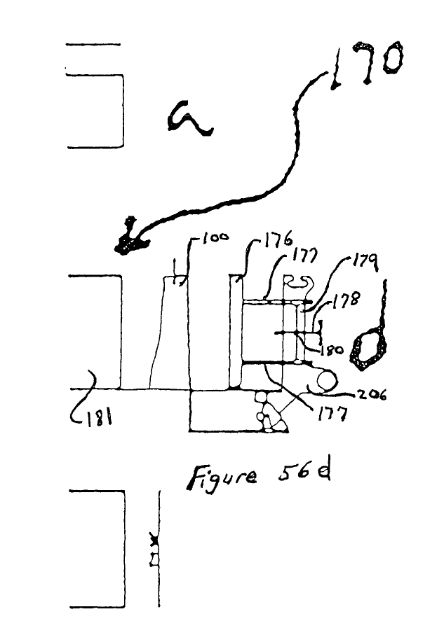

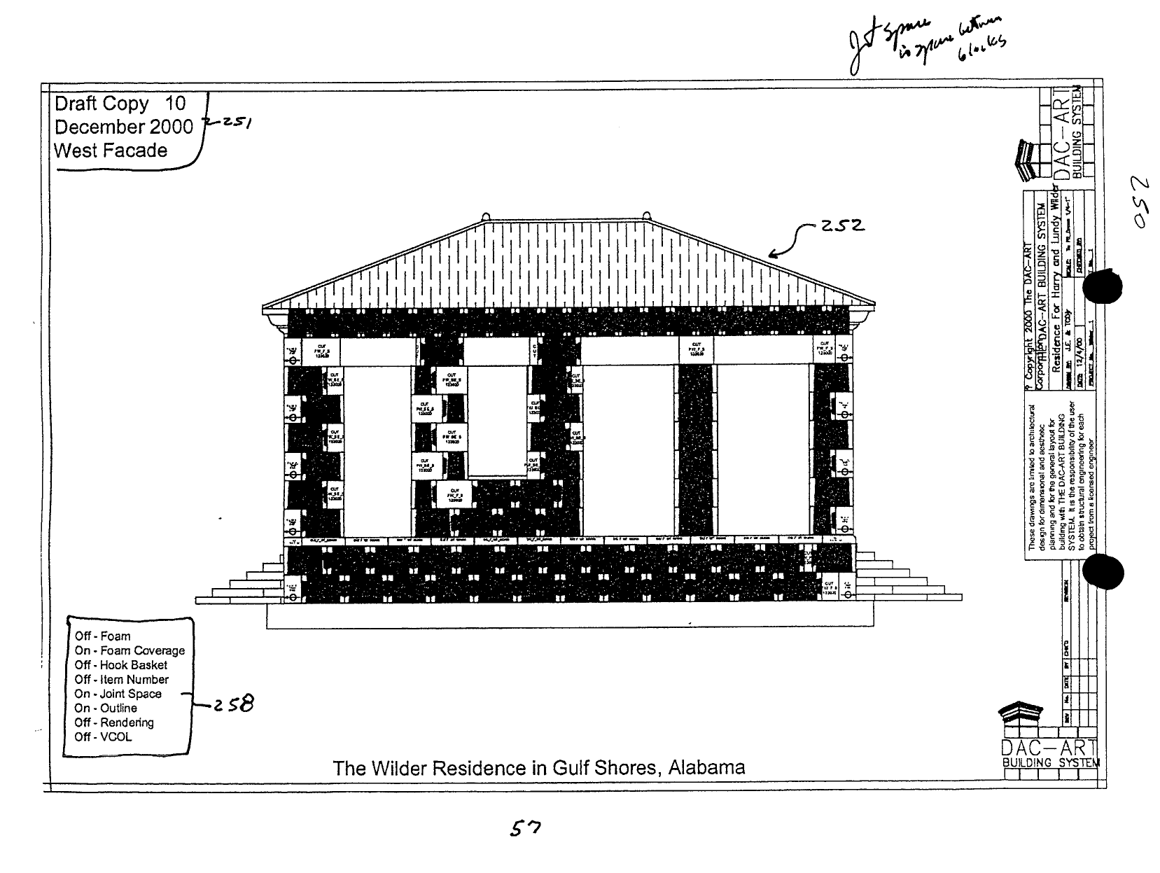

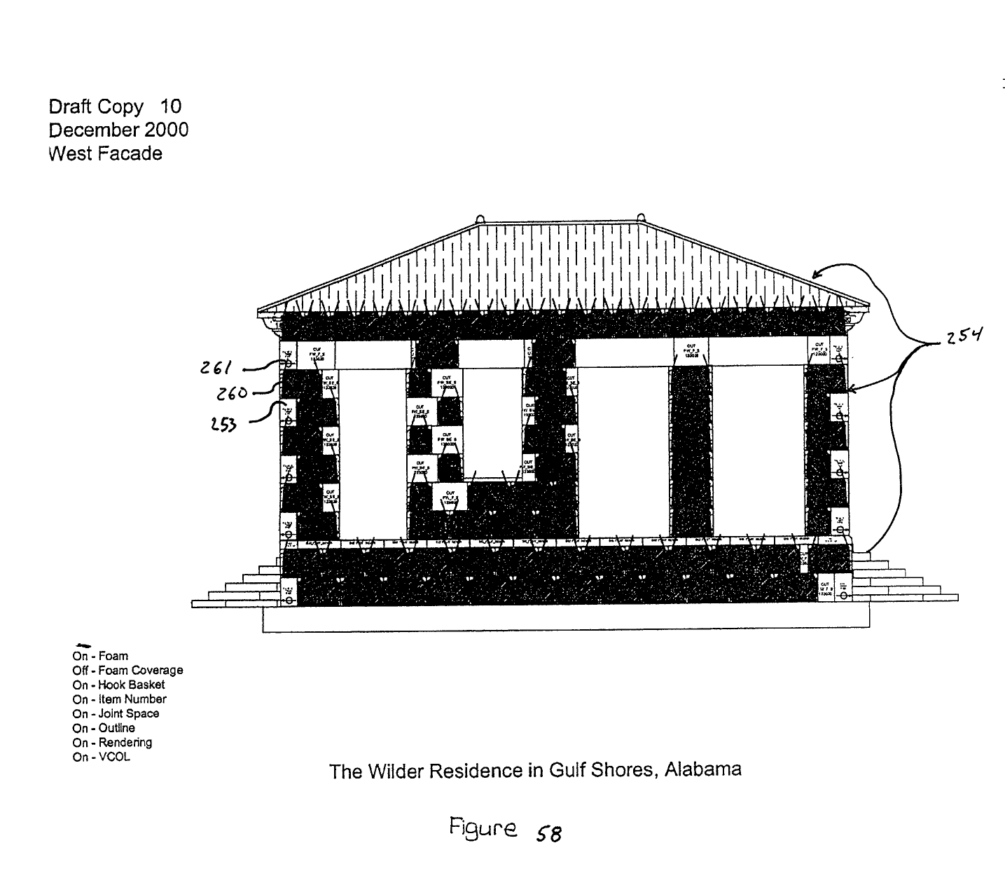

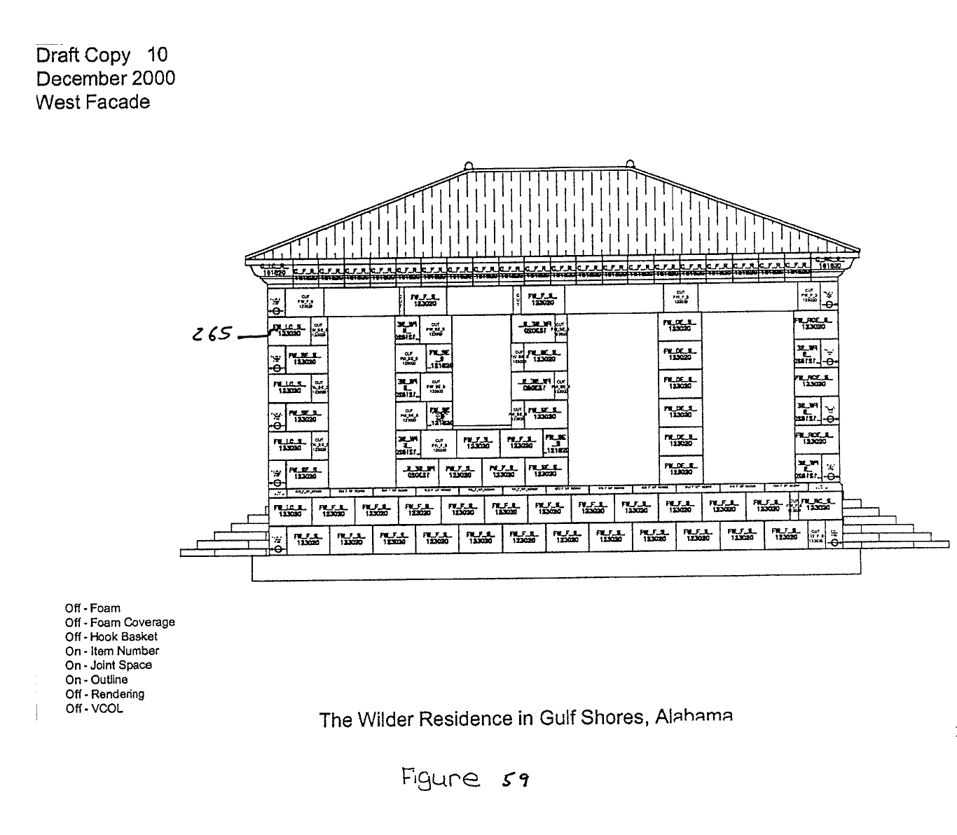

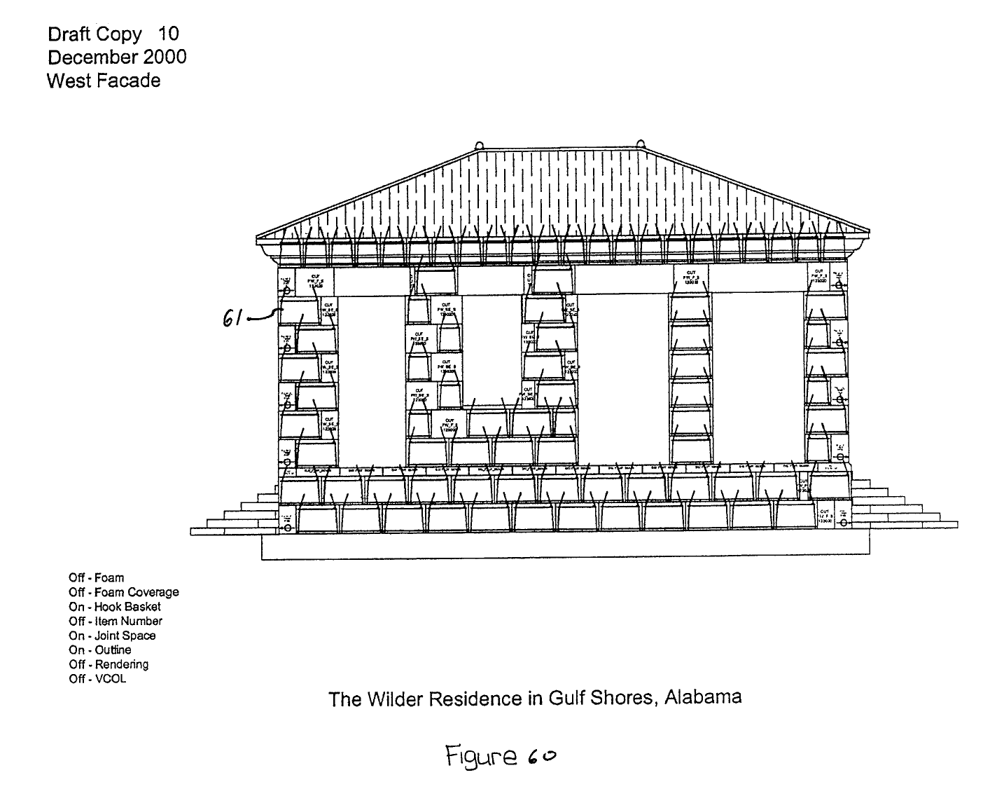

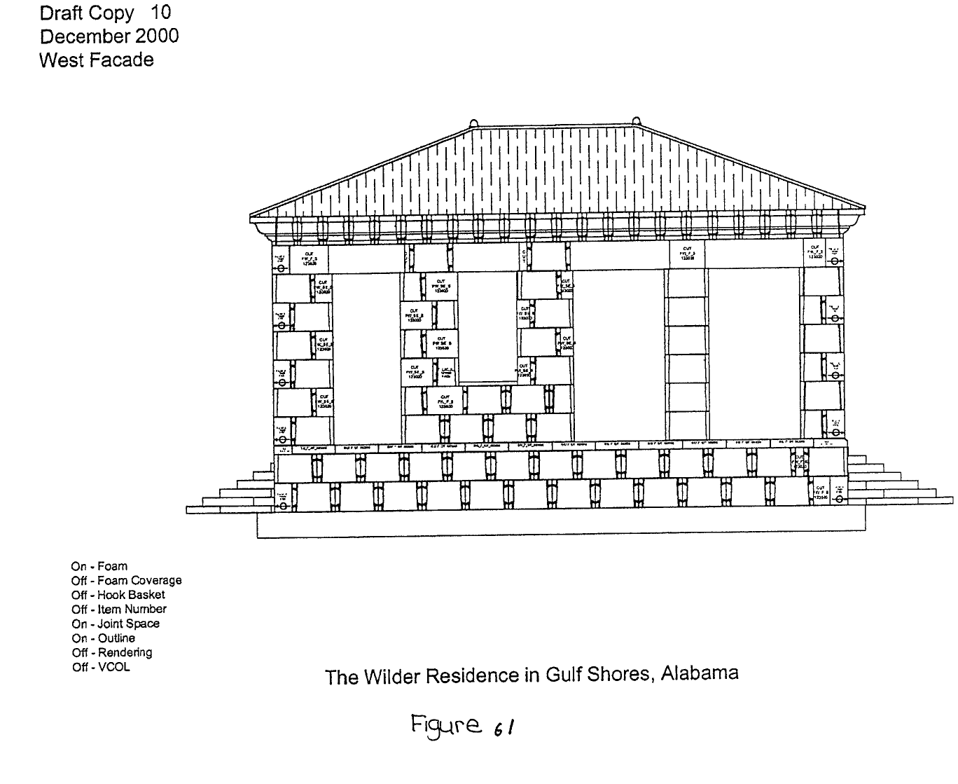

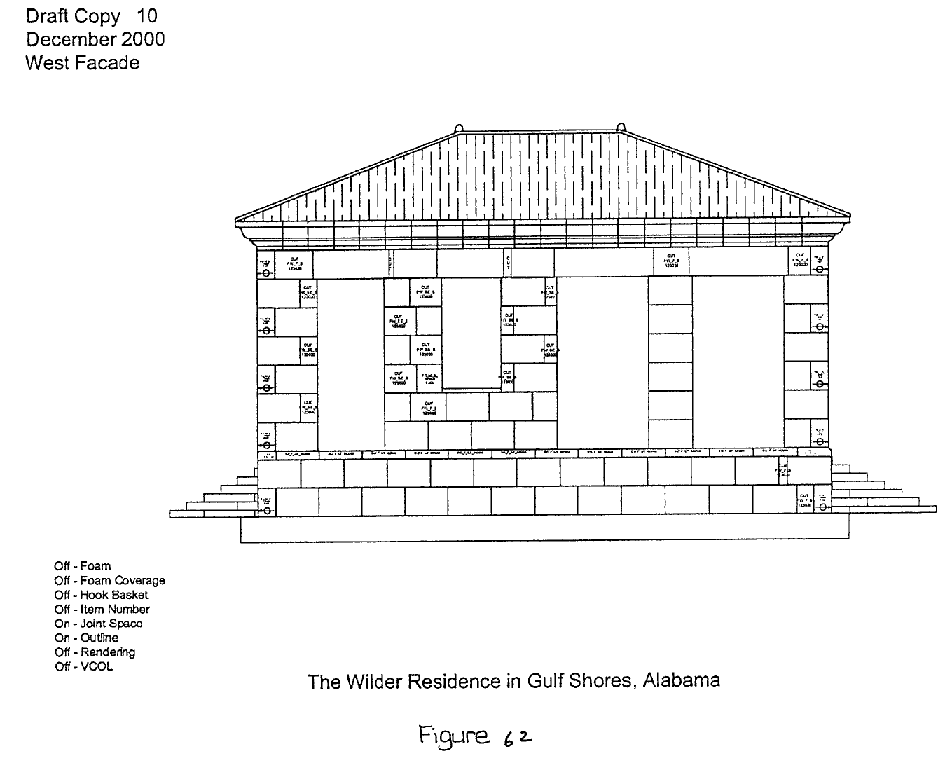

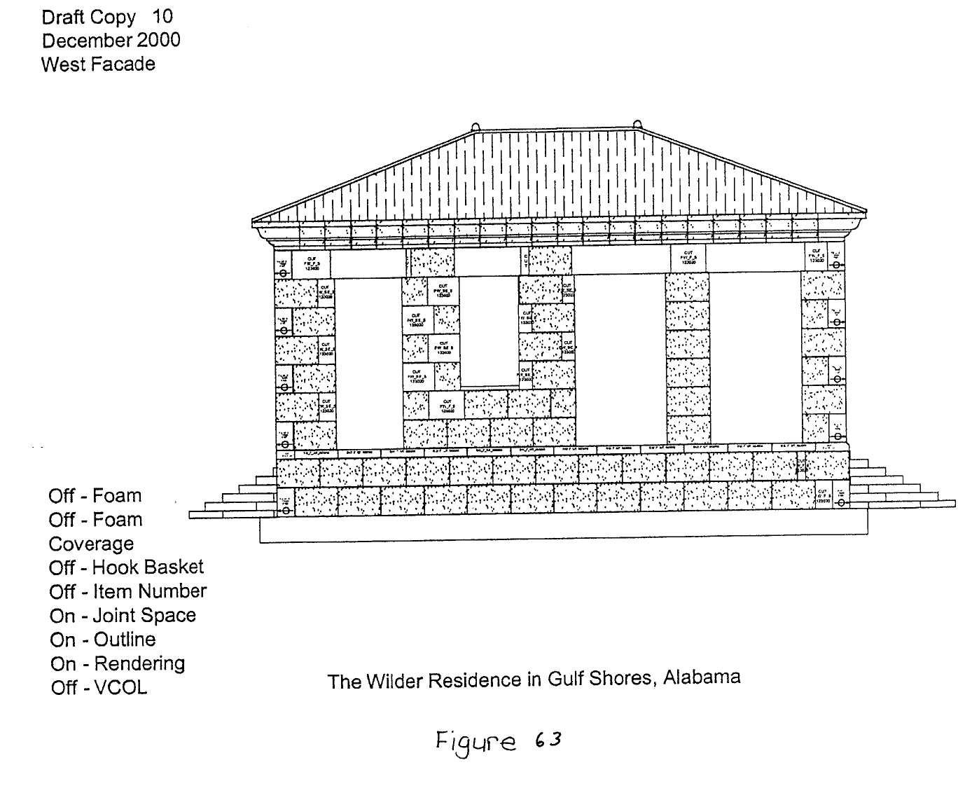

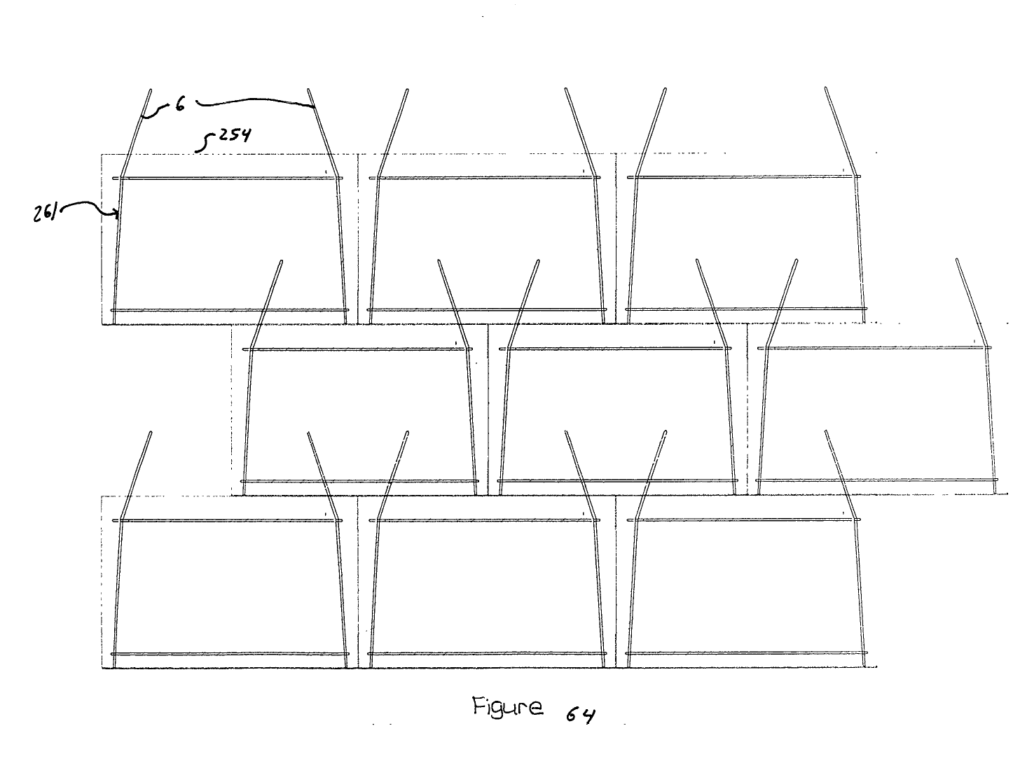

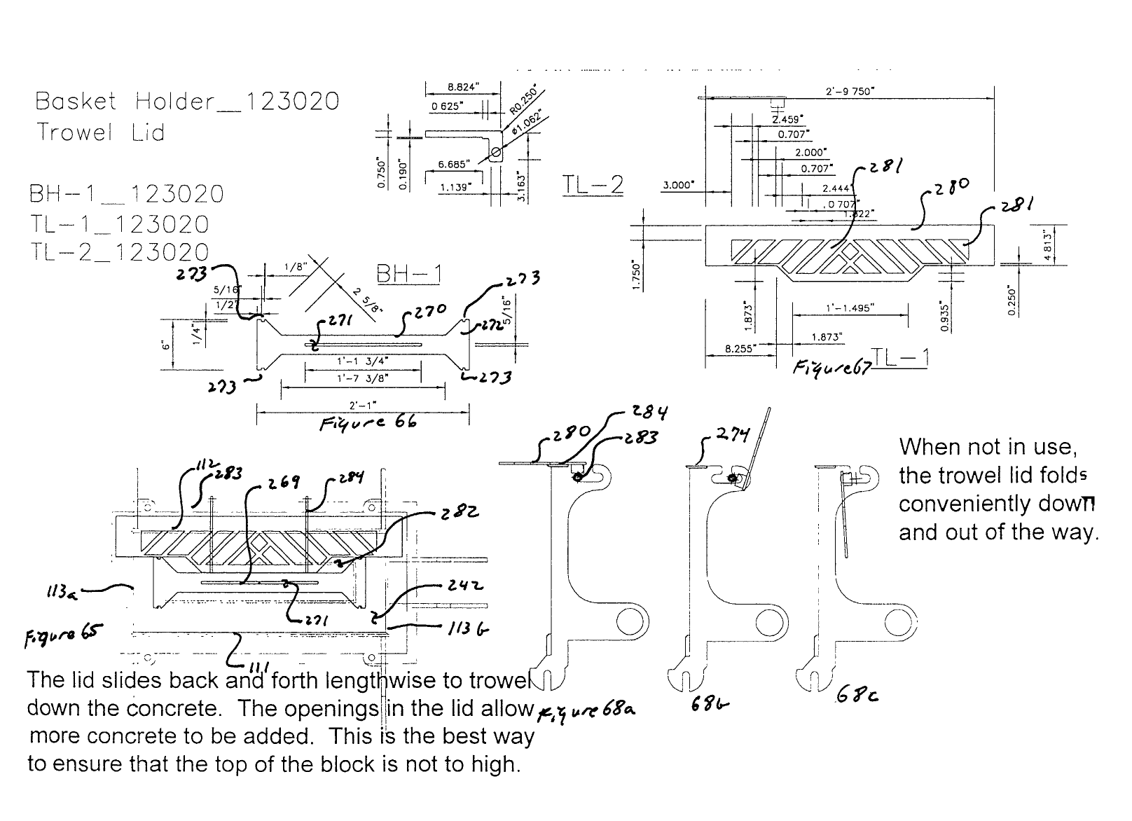

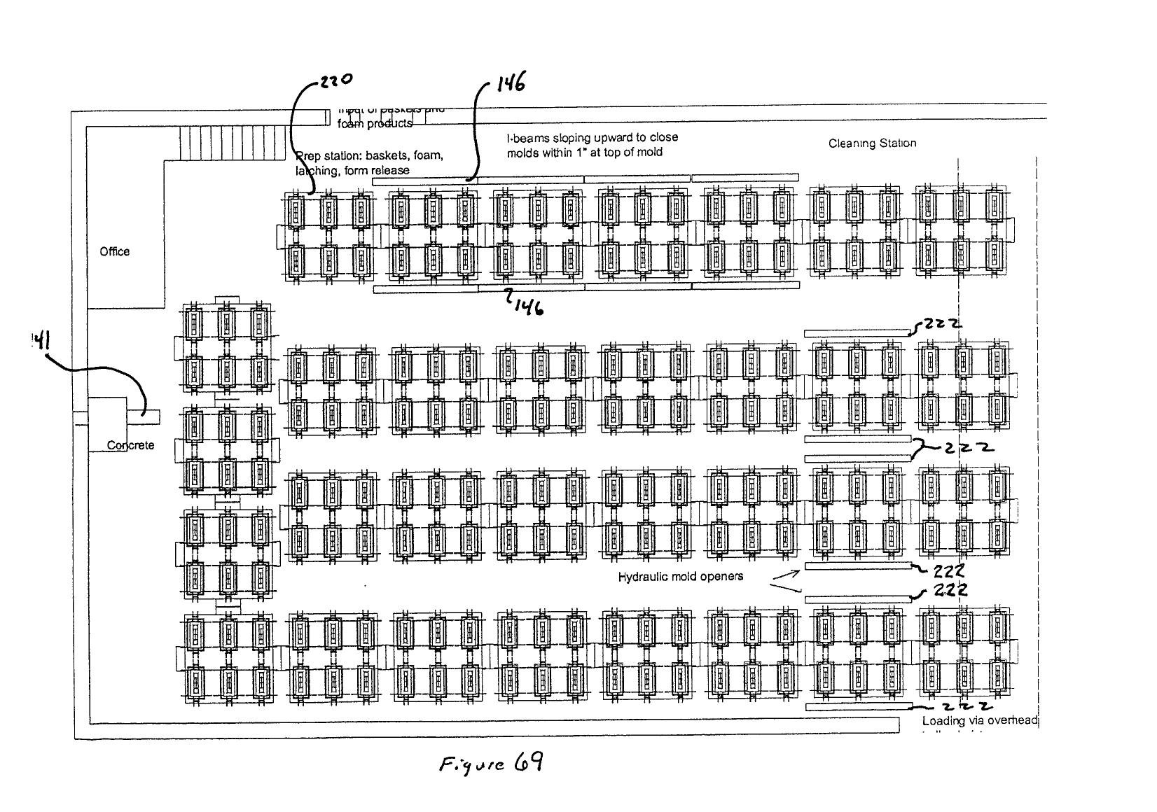

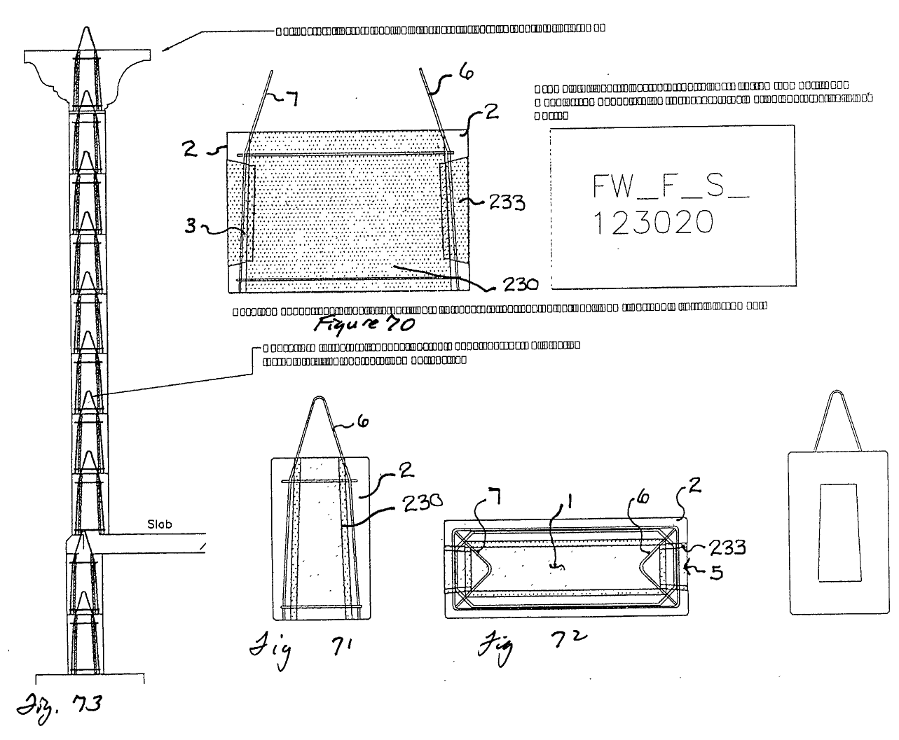

FIG. 56 shows a factory layout incorporating a series of blocks movable to stations for hoists, concrete, preparation, cleaning and opening.

FIGS. 69 through 64 show views of a house plan utilizing the block system described herein. In this case, by exposing various layers, the different technicians may determine that the house has fully compatible foam inserts and passageways which connect. In addition, the user may determine where additional structural metal is necessary.

In this case, each of the views has a view designation 251, a view 252, and a list of displayed layers 258. These may be changed as shown in the various figures. In these cases, there are views of the joint spaces 253 (the spaces between blocks, the outline of the house 254, the foam cores 260, the wire baskets 261 and the names or block designations 265 of the specific blocks used to manufacture the structure from a database of blocks having specific designations 265.

FIG. 64 shows a detail of a specific section of the blocks showing the interaction of the wiring with the basic block structure by outline 254.

These drawings show how the method of planning for construction with these blocks defining passages comprises the steps of:

a) electronically drawing a plurality of views of a plurality of blocks comprised of different parts said drawings separating by layer the different parts of the blocks;

b) electronically drawing a preliminary house plan;

c) electronically incorporating the plurality of blocks in the house plan so that the house is constructed by the blocks;

d) electronically displaying the needed portions of the block required for finishing the house plan;

e) electronically editing the drawing incorporating finish items into the plan;

f) and wherein at least a plurality of the blocks are comprised of a plurality of layers including a designation layer designating an alpha numeric name for particular blocks, at least one passage through the block, at least one reinforcing cage, and at least one insulating layer.

By just exposing the passages, plumbing, electrical and other utilities may be planned based on where the openings are present. Also, blocks may be substituted in order to provide the appropriate passages. The blocks have specific size limitations which make it easy to define blocks for a particular area.

FIGS. 65 through 68 show how the centering bar 269 shown in the various structures described above may receive a centering device 270 which is centered on the centering channel 271. The wide portion 272 of the centering device 270 has centering notches 273 which serve to receive the guide rods 6 and 7 in order to center the wire basket 261 before pouring and hold it in place while pouring.

The top wing gap 209 can hold a bar 283 which can receive holding arms 284 which support a trowel 280 which defines a plurality of trowel openings 281 which allow the concrete to be removed and the top surface of the block to be smoothed. The top of the wings may have leveling pads 284 which keep the trowel 280 at a desired level above the concrete in mold. As shown in FIGS. 68a-c the trowel is designed to be moved out of the way.

FIGS. 56a-d show a log type block 170. In a log block 170, there are multiple cages 171 and 172 within a single cast log block 170. At least one log chamber 173 is formed within the log block 170. In FIG. 65b, it can be seen that the chamber 173 is comprised of a large chamber 175 defined within each of the cages 171 in the block in question and a connecting chamber 174 which serves the purpose of joining the two large chambers 175.

The block shown in FIG. 56a-d shows how multiple plugs having cores joined together may create unique passages through all or part of a block's interior as well as providing additional support for cages 171.

FIG. 50d shows a side view of a mold for making a log block. In order to control the width, at least one of the walls is a special adjustable wall 176 which may be moved in or out on a plurality of arms 177 which are adjustably mounted on a screw 178 on the main wall 179 which main wall 179 is designed, other than the nut means 180 for holding the screw 178 as the walls in FIGS. 32-36. In FIG. 56d, there is a fixed wall 181 opposite the pivoting wall 179.

FIG. 56a shows a cross sectional view of the log block 150. FIG. 65c shows the cage which is an integral part of the block 150.

FIG. 70 shows a transparent area of block made using modified cores as shown in FIG. 38. Here both the left and right knockouts 234 are removed and replaced with side cores 233 so concrete coming into the top can flow through the bottom, the left side and the right side.

FIG. 71 shows a side view of the block shown in FIG. 70.

FIG. 72 is a top view of the block of FIG. 1.

FIG. 73 shows a side view of a wall showing how the holes in the bottoms with higher blocks are aligned with the middle of lower blocks to facilitate stacking.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1. A mold for constructing blocks from a poured matrix comprising:
a. base having a base perimeter;
b. A plurality of walls having a top end having a length contacting the base perimeter along the length of the plurality of walls and a mold top at the top end;
c. At least one wall receiving means for releasably holding the plurality of walls in contact with the base so a chamber is formed by the walls and the base;
d. At least one separate means for pulling at least one of the plurality of walls away from the base perimeter.

2. The mold of claim 1 wherein the at least one of the walls further comprises (a) at least one wing means offset from the wall for attaching the at least one separator means and providing leverage by way of the offset.

3. The mold of claim 2 wherein the walls further comprises a second wing aligned with and parallel with the at least one wing.

4. The invention of claim 2 wherein at least 2 of the walls have a wing means.

5. The mold of claim 1 wherein the wall receiving means comprises an extension from the wall and a pivot means for pivotally holding the pivot means to the mold base.

6. The mold of claim 5 wherein pivot means comprises a floor with a bracket extending upward from the floor holding a bar and wherein the extension defines a opening fitting over the bar.

7. The invention of claim 6 wherein the floor further comprises a floor plate for receiving brackets and providing support against a surface.

8. The mold of claim 1 wherein the mold further comprises at least one plug having a first and a second end and wherein the first end is attached to the base and the wall second end extends into the chamber.

9. The mold of claim 1 wherein the mold further comprises at least one side plug having a first end and a second end and wherein the first end is attached to a at least one wall and wherein the second end extends into the chamber.

10. The mold of claim 8 wherein the mold further comprises at least one side plug having a first end and a second end and wherein the first end is attached to at least one wall and the second end approximately contacts the at least one plug.

11. The invention of claim 8 wherein the plug first end is wider than the plug second end.

12. The invention of claim 9 wherein the plug first end is wider than the plug second end.

13. The invention of claim 8 wherein the plug further combines a lug core at least partially covering this plug length between the plug first end and the plug second end.

14. The invention of claim 8 wherein the plug second end further comprises a centering means and a wire alignment means centered on the centering means for aligning a wire cage around the at least one plug.

15. The invention of claim 14 wherein the wire cage further comprises an architectural block for use with at least one second block having a second block opening comprising:
(a) a top and a bottom, and further comprising a first side, a second side, a third side and a fourth side and said sides, top and bottom defining an enclosure which enclosure defines at least one first block opening which is continuous with a passage through the block which passage is continuous with at least one second block opening in the second block when the second block is placed against the architectural block, said architectural block further comprising:
(b) at least one first guide rod extending from within the first side to within the second side and across the at least one first block opening and wherein the at least one first guide rod is further described as extending above the top of the block.

16. The mold of claim 1 further comprising at least one high wing for supporting a pivot means and a leveling means and a trowel slidable along said pivot means held at a desired level by the level means along the top end.

17. The invention of claim 16 wherein the trowel means further comprises: a holding means, a bar 283 held by the holding means at the top of the mold; at least one holding arm 284 slidably connected to the bar 283; and a leveling means 284 which supports the at least one holding arm 284 at a desired level above the mold and at least one trowel 280 held by the holding arm 284.

18. The invention of claim 17 where the trowel 280 defines a plurality of trowel openings 281 which allow the concrete to come up through and be removed from the trowel openings 281.

19. The invention of claim 1 wherein the disconnecting means comprises a plurality of interlocking pipes attachable to the wings and a beam which is attachable to a jack for pulling the pipes and I-beam together.

20. The invention of claim 1 wherein at least one of the walls is adjustable inward relative to the wall receiving means so that the thickness of the at least one of the walls may be varied by varying the distance between the wall and the wall receiving means.

21. An architectural block having an interior and an exterior and further comprising a core of non-absorbent material running between the block interior and block exterior.

22. The block of claim 21 wherein the block further comprises a chamber and wherein the core surrounds the chamber.

23. An architectural block(2) made of a concrete material for use with at least one second block having a second block opening(4) comprising;
(a) a top (2e) and a bottom (2f), and further comprising a first side (2a), a second side (2b), a third side (2c) and a fourth side (2d) and said sides, top and bottom defining an enclosure which enclosure defines at least one first block opening (1) which is continuous with a passage through the block which passage is continuous with at least one second block opening (4) in the second block when the second block is placed against the architectural block, said architectural block further comprising; a core cover of a different material from the block imbedded within the block around the passage.

24. The invention of claim 9 wherein the top of the plug slants less than the bottom of the plug to allow the plug.

25. A method of constructing with blocks defining passages comprising:
a) electronically drawing a plurality of views of a plurality of blocks comprised of different parts said drawings separating by layer the different parts of the blocks;
b) electronically drawing a preliminary house plan;
c) electronically incorporating the plurality of blocks in the house plan so that the house is constructed by the blocks;
d) electronically displaying the needed portions of the block required for finishing the house plan;
e) electronically editing the drawing incorporating finish items into the plan.

26. The method of claim 25 wherein at least a plurality of the blocks are comprised of a plurality of layers including a designation layer designating an alpha numeric name for particular blocks, at least one passage through the block, at least one reinforcing cage, and at least one insulating layer.

27. An architectural block (2) made of a matrix material such as concrete for use with at least one second block having a second block opening (4) comprising;
(A) a top (2e) and a bottom (2f), and further comprising a first side (2a), a second side (2b), a third side (2c) and a fourth side (2d) and wherein said sides, top and bottom define an enclosure which enclosure defines at least one first block opening (1) which is continuous with a passage through the block which passage is continuous with at least one second block opening (4) in the second block when the second block is placed against the architectural block, said architectural block further comprising; a core cover of a non-absorbent material from the block imbedded within the block around the passage.

28. The block of claim 27 wherein the block further comprises an interior and exterior surface and wherein the non-absorbent material provides a barrier between the interior and exterior surface.

29. The block of claim 27 further wherein the block further comprises at lease one second passage.

30. The block of claim 29 wherein the first passage and second passage further comprising a third passage providing access between the first passage and the second passage.

31. The block of claim 27 further comprising a reinforcing cage embedded within the block around the core.

32. The block of claim 31 further comprising at least one lifting arm extending from the cage over the block and back to the cage.

33. A mold system for constructing concrete blocks by pouring concrete into an assembled mold and wherein said blocks have at least one internal opening comprising:
a) at least one platform;
b) a carrying means for moving the platform;
c) a plurality of base members for forming the floor of the blocks;
d) a carrying means for holding the base members above the platform;
e) a plurality of walls attachable to the at least one base for forming the walls of the blocks;
f) at least one wall receiving means for joining at least one of the plurality of walls to at least one of the plurality of base members;
g) at least one plug attachable to at least one of the plurality of walls or base for defining an internal opening within the block;
h) a separating means for mechanically separating the walls and the base from concrete added to the mold.

34. The invention of claim 33 wherein the wall receiving means comprises:
a) a plurality of gaps in edge of the base each for receiving at least one of the plurality of bottom fittings and a pivot means for supporting the wall so that it may be rotated within the gap; supported on the platform under the base member and wherein the wall comprises a bottom fitting insertable through the gap and pivotably onto the pivot, said bottom fitting defining a slanting wall ending in a floor offset from the pivot under one of the plurality of base members in an assembled mold, a rod means for connecting the floor to the one of the plurality of base members;

35. The invention of claim 34 wherein the wall further comprises at least one wing offset from the pivot opposite the offset of the floor defining a connecting means for connecting the wall to the separating means.

36. A Method of using construction blocks having at least one first side and a top above the first side (2a) and a first opening (1) in the top (2e) and at least one second side (2b) opposed from the first side (2a) and wherein the first opening (1) is located between the first side (2a) and second side (2b) and wherein the blocks further comprise a bottom (2f), said bottom defining a bottom opening (4) with at least one passage through the block from the first opening (1) to the bottom opening (4) comprising the steps of:
(A) placing at least one reinforcing member (6) within the passage of at least one first block (21)and extending out of the at least one first block top (2e) and across the at least one first block first opening (1);
(B) stacking a second block (20) so that the at least one reinforcing member (6) extends within the bottom opening (4) of the second block (20) so that the passage of the second block (20) is continuous with at least a portion of the passage of at least one first block (21) to form a common passage (71);
(C) pouring concrete within the common passage (71).

37. The method of claim 36 wherein the step of placing a reinforcing member (6) further comprises the step of placing the reinforcing member (6) within the second side (2g) of the at least one first block.

38. The method of claim 37 wherein the step of placing the reinforcing member further comprises the step of placing a cage (3) of reinforcing material within the block (21) and around the first opening (1) and attaching the reinforcing member to the cage (3).

39. The method of claim 37 wherein the step of stacking further comprises the step of lifting at least one second block (20) onto first block (21) by way of the reinforcing member (6).

40. The method of claim 37 wherein reinforcing member further comprises at least one lifting rod means (6) so that when the second block may be lifted by the lifting rod means.

41. The method of claim 36 wherein the reinforcing member further comprises an aligning means (6) to align the bottom opening (4) of the second block (20) with the top opening (1) first block (20).

42. The method of claim 41 wherein the aligning means is a rod (6) extending upward from the first block and against the side (14) of the bottom opening (4) in the second block (20) so that the bottom opening (4) is aligned with at least a portion of the top opening (1) of the at least one first block (21).

43. The method of claim 37 wherein the blocks further comprise an exterior finishing means(64) for providing a finish to the exterior surface and wherein the method further comprises the step of alining the finishing means(64) of adjoining blocks so as to form a line of finishing means at the desired location for applying a finish.

44. The method of claim 43 wherein the finishing means further comprises a stud, a bolt, a nail, a brick and a metal plate.
